(19) United States
(12) Patent Application Publication
(10) Pub. No.: US 2016/0212632 A1
(43) Pub. Date: Jul. 21, 2016

(54) EFFICIENT PHYSICAL CELL IDENTIFIER COLLISION AND CONFUSION AVOIDANCE USING LTE-DIRECT

(71) Applicant: QUALCOMM Incorporated, San Diego, CA (US)

(72) Inventors: Srujith Reddy KATAMREDDY, Telangana (IN); Georgios TSIRTSIS, London (GB); Michaela VANDERVEEN, Tracy, CA (US); Mohana Rao SASANAPURI, Telangana (IN)

(21) Appl. No.: 14/598,427

(22) Filed: Jan. 16, 2015

(51) Int. Cl. H04W 24/02; H04W 8/00; H04W 84/04

(52) U.S. Cl. CPC H04W 24/02; H04W 84/045; H04W 8/005

(57) ABSTRACT

The disclosure generally relates to avoiding physical cell identifier (PCI) collision and confusion using LTE-Direct expressions. In particular, a small cell may discover LTE-Direct expressions that include PCIs associated with neighbor small cells and select (or reselect) a local PCI to ensure that the local PCI differs from the PCIs associated with each neighbor small cell. Furthermore, the small cell may detect PCI confusion where multiple neighbors broadcast LTE-Direct expressions with the same PCI and different E-UTRAN Cell Global Identifiers (eCGIs) and/or detect PCI confusion in neighbor small cells where the local PCI matches the PCI used in a neighbor's neighbor and the local eCGI used in the small differs from that used in the neighbor's neighbor. The small cell may additionally broadcast LTE-Direct expressions that include at least the local PCI and eCGI to enable neighbors to avoid PCI collision and confusion in the same manner.

### TECHNICAL FIELD

The disclosure relates to wireless communications, and in particular, to avoiding physical cell identifier (PCI) collision and confusion in wireless communications systems.

### BACKGROUND

Wireless communication systems are widely deployed to provide various types of communication content, such as voice, data, multimedia, and so on. Typical wireless communication systems are multiple-access systems that can support communication with multiple users by sharing available system resources (e.g., bandwidth, transmit power, etc.). Examples of such multiple-access systems include Code Division Multiple Access (CDMA) systems, Time Division Multiple Access (TDMA) systems, Frequency Division Multiple Access (FDMA) systems, Orthogonal Frequency Division Multiple Access (OFDMA) systems, and others. These systems are often deployed in conformity with specifications such as Third Generation Partnership Project (3GPP), 3GPP Long Term Evolution (LTE), Ultra Mobile Broadband (UMB), Evolution Data Optimized (EV-DO), Institute of Electrical and Electronics Engineers (IEEE), etc.

In cellular networks, “macro cell” base stations provide connectivity and coverage to a large number of users over a certain geographical area. A macro network deployment is carefully planned, designed, and implemented to offer good coverage over the geographical region. Even such careful planning, however, cannot fully accommodate channel characteristics such as fading, multipath, shadowing, etc., especially in indoor environments. Indoor users therefore often face coverage issues (e.g., call outages and quality degradation) resulting in poor user experience. Accordingly, to improve wireless coverage in indoor environments and otherwise difficult-to-cover areas like train stations, tunnels, office buildings, and residential homes, additional “small cell,” typically low-power base stations have recently begun to be deployed to supplement conventional macro networks. Small cell base stations may also provide incremental capacity growth, richer user experience, and so on.

Recently, small cell LTE operations, for example, have been extended into the unlicensed frequency spectrum such as the Unlicensed National Information Infrastructure (U-NII) band used by Wireless Local Area Network (WLAN) technologies. This extension of small cell LTE operation is designed to increase spectral efficiency and hence capacity of the LTE system. However, in unplanned and self-organizing networks (SONs), there is a good probability that more than one cell with the same physical cell identifier (PCI) will provide coverage in a particular area, which generally results in a collision event that occurs when a user device is in the coverage area of two or more cells with the same PCI and/or a confusion event that occurs where a serving cell has multiple neighbors that share the same PCI. In general, PCI collisions and confusion can result in ambiguous operation, for example, during handover. Accordingly, systems and methods to enable efficient PCI collision and confusion avoidance in wireless communications systems are desired.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments disclosed herein in a simplified form to precede the detailed description presented below.

According to various aspects, a method for avoiding physical cell identifier (PCI) collision and confusion may comprise discovering, at a small cell, one or more LTE-Direct expressions broadcasted from one or more neighbor small cells, wherein the one or more LTE-Direct expressions include one or more PCIs used to identify the one or more neighbor small cells, selecting, at the small cell, a local PCI that differs from the one or more PCIs used to identify the one or more neighbor small cells, and configuring, at the small cell, a local LTE-Direct expression to broadcast, wherein the configured local LTE-Direct expression includes at least the selected local PCI.

According to various aspects, a small cell may comprise means for discovering one or more LTE-Direct expressions broadcasted from one or more neighbor small cells, wherein the one or more LTE-Direct expressions include one or more PCIs used to identify the one or more neighbor small cells, means for selecting a local PCI that differs from the one or more PCIs used to identify the one or more neighbor small cells, and means for configuring a local LTE-Direct expression to broadcast, wherein the configured local LTE-Direct expression includes at least the selected local PCI.

According to various aspects, a computer-readable storage medium may have computer-executable instructions recorded thereon, wherein executing the computer-executable instructions on one or more processors may cause the one or more processors to discover one or more LTE-Direct expressions broadcasted from one or more neighbor small cells, wherein the one or more LTE-Direct expressions include one or more PCIs used to identify the one or more neighbor small cells, select a local PCI that differs from the one or more PCIs used to identify the one or more neighbor small cells, and configure a local LTE-Direct expression to broadcast, wherein the configured local LTE-Direct expression includes at least the selected local PCI.

According to various aspects, a method for detecting PCI confusion may comprise discovering, at a small cell, a first LTE-Direct expression broadcasted from a first neighbor small cell, wherein the first LTE-Direct expression includes at least a first PCI and a first E-UTRAN Cell Global Identifier (eCGI) associated with the first neighbor small cell, discovering, at the small cell, a second LTE-Direct expression broadcasted from a second neighbor small cell, wherein the second LTE-Direct expression includes at least a second PCI and a second eCGI associated with the second neighbor small cell, and detecting, at the small cell, PCI confusion in response to determining that the first PCI matches the second PCI and the first eCGI differs from the second eCGI.

According to various aspects, a small cell may comprise means for discovering a first LTE-Direct expression broadcasted from a first neighbor small cell, wherein the first LTE-Direct expression includes at least a first PCI and a first eCGI associated with the first neighbor small cell, means for discovering a second LTE-Direct expression broadcasted from a second neighbor small cell, wherein the second LTE-Direct expression includes at least a second PCI and a second eCGI associated with the second neighbor small cell, and means for detecting PCI confusion in response to determining that the first PCI matches the second PCI and the first eCGI differs from the second eCGI.

According to various aspects, a computer-readable storage medium may have computer-executable instructions recorded thereon, wherein executing the computer-executable instructions on one or more processors may cause the one or more processors to discover a first LTE-Direct expression broadcasted from a first neighbor small cell, wherein the first LTE-Direct expression includes at least a first PCI and a first eCGI associated with the first neighbor small cell, discover a second LTE-Direct expression broadcasted from a second neighbor small cell, wherein the second LTE-Direct expression includes at least a second PCI and a second eCGI associated with the second neighbor small cell, and detect PCI confusion in response to determining that the first PCI matches the second PCI and the first eCGI differs from the second eCGI.

According to various aspects, a method for detecting PCI confusion may comprise discovering, at a small cell, an LTE-Direct expression broadcasted from a neighbor small cell, wherein the LTE-Direct expression includes a PCI and an eCGI associated with a neighbor of the neighbor small cell, and detecting, at the small cell, PCI confusion inside the neighbor small cell in response to the PCI included in the discovered LTE-Direct expression matching a local PCI used in the small cell and that the eCGI included in the discovered LTE-Direct expression differing from a local eCGI used in the small cell.

According to various aspects, a small cell may comprise means for discovering an LTE-Direct expression broadcasted from a neighbor small cell, wherein the LTE-Direct expression includes a PCI and an eCGI associated with a neighbor of the neighbor small cell and means for detecting PCI confusion inside the neighbor small cell in response to the PCI included in the discovered LTE-Direct expression matching a local PCI used in the small cell and that the eCGI included in the discovered LTE-Direct expression differing from a local eCGI used in the small cell.

According to various aspects, a computer-readable storage medium may have computer-executable instructions recorded thereon, wherein executing the computer-executable instructions on one or more processors may cause the one or more processors to discover an LTE-Direct expression broadcasted from a neighbor small cell, wherein the LTE-Direct expression includes a PCI and an eCGI associated with a neighbor of the neighbor small cell and detect PCI confusion inside the neighbor small cell in response to the PCI included in the discovered LTE-Direct expression matching a local PCI used in the small cell and that the eCGI included in the discovered LTE-Direct expression differing from a local eCGI used in the small cell.

Other objects and advantages associated with the various aspects and/or embodiments disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates an exemplary mixed-deployment wireless communication system including macro cell base stations and small cell base stations, according to various aspects.

FIG. 2 illustrates an exemplary downlink frame structure for LTE communications, according to various aspects.

FIG. 3 illustrates an exemplary uplink frame structure for LTE communications, according to various aspects.

FIG. 4 illustrates an exemplary small cell base station with co-located radio components (e.g., LTE and Wi-Fi) configured for unlicensed spectrum operation, according to various aspects.

FIG. 5 illustrates an exemplary wireless communication system in which a physical cell identifier (PCI) collision event may occur, according to various aspects.

FIG. 6 illustrates an exemplary wireless communication system in which a physical cell identifier (PCI) confusion event may occur, according to various aspects.

FIG. 7 illustrates an exemplary wireless communication system in which LTE-Direct (LTE-D) expressions may be used to avoid PCI collision and confusion, according to various aspects.

FIG. 8 illustrates an exemplary LTE-D expression that may be used to avoid PCI collision and confusion, according to various aspects.

FIG. 9 illustrates an exemplary method to select or reselect a PCI in a manner that may avoid collisions using LTE-D expressions, according to various aspects.

FIG. 10 and FIG. 11 illustrate exemplary methods to detect and report potential PCI confusion using LTE-D expressions, according to various aspects.

FIG. 12 illustrates an exemplary simplified block diagram of several sample aspects of components that may be employed in communication nodes and configured to support communication as described herein.

### DETAILED DESCRIPTION

Various aspects are disclosed in the following description and related drawings to show examples directed to specific exemplary embodiments. Alternate embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein describes particular embodiments only and should be construed to limit any embodiments disclosed herein. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each aspect and/or embodiment described herein, the corresponding form of any such aspect and/or embodiment may be described herein as, for example, “logic configured to” perform the described action.

A client device, referred to herein as a user equipment (UE), may be mobile or stationary, and may communicate with a radio access network (RAN). As used herein, the term “UE” may be referred to interchangeably as an “access terminal” or “AT”, a “wireless device”, a “subscriber device”, a “subscriber terminal”, a “subscriber station”, a “user terminal” or UT, a “mobile terminal”, a “mobile station” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, Wi-Fi networks (e.g., based on IEEE 802.11, etc.) and so on. UEs can be embodied by any of a number of types of devices including but not limited to PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse traffic channel or a downlink/forward traffic channel. Moreover, various embodiments are described herein in connection with a base station (BS) or access node (AN), wherein a BS can be utilized to communicate with UEs and can also be referred to as an access point (AP), a femto node, a pico node, a Node B, an Evolved Node B (eNodeB or eNB), or other suitable terminology.

Various embodiments described herein may be employed in a network that includes macro scale coverage (e.g., a large area cellular network such as a 3G network, typically referred to as a macro cell network) and smaller scale coverage (e.g., a residence-based or building-based network environment). As a UE moves through such a network, the UE may be served in certain locations by BSs that provide macro coverage while the UE may be served at other locations by BSs that provide smaller scale coverage. In some aspects, the smaller coverage nodes may be used to provide incremental capacity growth, in-building coverage, and different services (e.g., for a more robust user experience). In the discussion herein, a node that provides coverage over a relatively large area may be referred to as a macro node, while a node that provides coverage over a relatively small area (e.g., a residence) may be referred to as a femto node. A node that provides coverage over an area smaller than a macro area and larger than a femto area may be referred to as a pico node (e.g., providing coverage within a commercial building). Accordingly, a cell associated with a macro node, a femto node, or a pico node may be referred to as a macro cell, a femto cell, or a pico cell, respectively, wherein each cell may be further associated with (e.g., divided into) one or more sectors. In various applications, other terminology may also be used to reference a macro node, a femto node, or a pico node. For example, a macro node may be configured or referred to as a BS, an access point, an eNB, a macro cell, and so on. Furthermore, a femto node may be configured or referred to as a Home NodeB (HNB), a Home eNodeB (HeNB), a BS, a femto cell, and so on.

Various embodiments described herein may provide efficient mechanisms to enable a cell to self-configure in a manner whereby a physical cell identifier (PCI) may be selected or reselected to avoid collisions or confusion with other nearby cells that may be using the same PCI. More particularly, in small cell deployments and/or mixed deployments in which one or more small cells are deployed in conjunction with one or more macro cells, PCI collision and PCI confusion are important issues that need to be addressed to mitigate ambiguous operation. For example, PCI collision may generally occur when a UE is in the coverage overlap of two or more cells that have the same PCI, which can result in significant channel estimation losses because the LTE physical layer (PHY or L1) is not designed to deal with PCI collisions, and which can further cause the UE to eventually enter radio link failure (RLF) depending on relative strengths associated with channels from the two or more cells that have the same PCI. Furthermore, PCI confusion may generally occur where a particular serving cell has two or more neighbors that share the same PCI such that the serving cell does not know which neighbor to handover a served UE.

Existing efforts to avoid PCI collision and PCI confusion generally employ network listening (NL) and other mechanisms based on L1 statistics to detect and/or avoid PCI collisions (e.g., channel quality indicator (CQI) statistics, Block Error Rate (BLER) statistics, handover statistics, etc.). Other approaches include configuring connected mode UEs to provide Automatic Neighbor Relationship (ANR) measurement reports and having eNBs, HeNBs, etc. exchange information (e.g., configuration messages, mobility messages, load information messages, etc.) over the X2 interface and/or over IP using the X2 application protocol (X2AP). As such, the eNBs, HeNBs, etc. can then use the exchanged information to build and/or update a Neighbor Relation Table (NRT) that may be used to detect and resolve PCI collisions and confusion. However, the above-mentioned solutions are not ideal in many scenarios. For example, the UE ANR method may only work for confusion detection. Furthermore, the methods that involve X2 signaling exchanges may increase network traffic and impose a burden with respect to processing the exchanged information.

Accordingly, various embodiments described herein may configure a small cell to use LTE-Direct (LTE-D) technology in order to find the PCI and the evolved UMTS Terrestrial Radio Access Network (E-UTRAN) Cell Global Identifier (eCGI) associated with one or more neighbor small cells while booting up and to periodically read the same information while running. More particularly, because small cells are often deployed over a macro cell to increase capacity and improve performance, an operator generally cannot configure each small cell separately. Accordingly, small cells are generally enabled for self-configuration, wherein configuring small cells to find the PCI and eCGI associated with neighbor small cells may assist with avoiding PCI collision and confusion because each small cell attempts to detect nearby PCIs and avoids using the detected PCIs during PCI selection and/or reselection procedures. Furthermore, as noted above, the small cells may be configured to use LTE-D technology to read the PCI and eCGI associated with the neighbor small cells, wherein LTE-D is a proposed 3GPP (Release 12) device-to-device (D2D) solution for proximate discovery. LTE-D dispenses with location tracking and network calls by directly monitoring for services on other LTE-D devices within a large range (˜500 m, line of sight) in a substantially continuous and battery efficient manner.

As such, in the various embodiments described herein, a small cell may create one or more expressions to use in LTE-D discovery messages, which may include at least the PCI and eCGI associated with the small cell and optionally further include the PCIs and eCGIs associated with one or more neighbor small cells. Furthermore, in addition to broadcasting expressions, the small cell may use LTE-D discovery to monitor and decode expressions broadcasted from neighbor small cells and use the broadcasted expressions from the neighbor small cells in a PCI selection/reselection procedure designed to avoid PCI collisions and PCI confusion. Accordingly, the small cell may generally broadcast expressions and monitor (or listen) for expressions to enable PCI self-configuration.

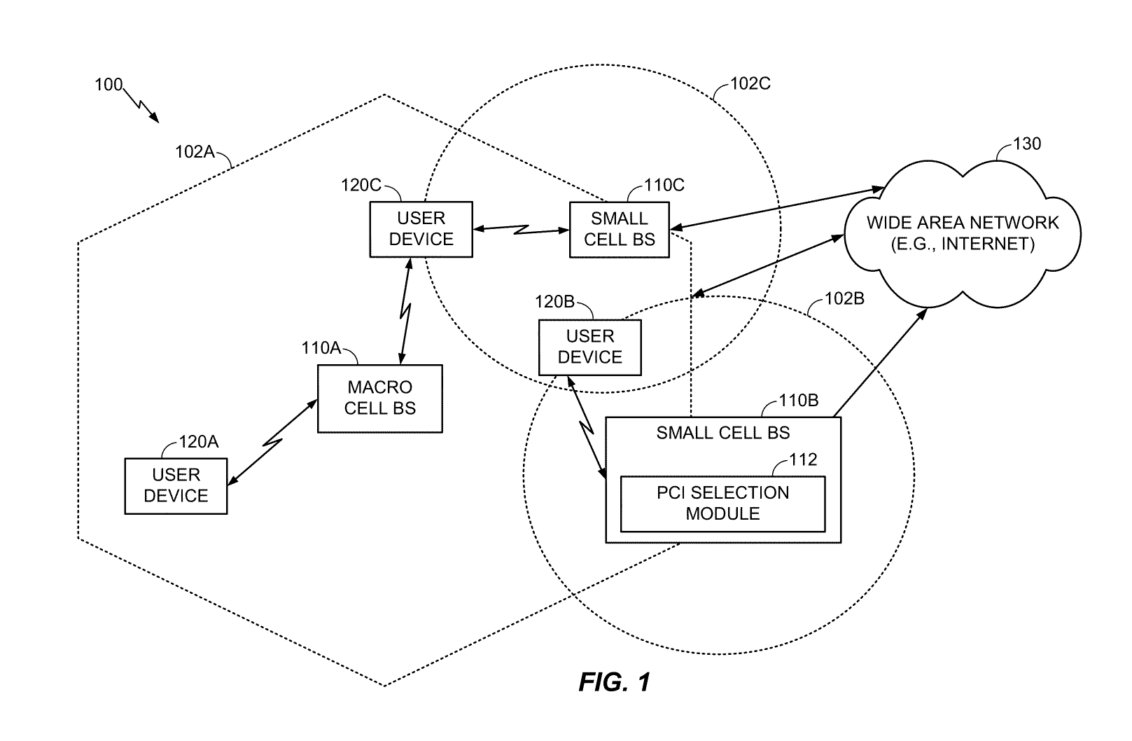

Referring to FIG. 1, a mixed-deployment wireless communication system 100 may include one or more small cell base stations deployed in conjunction with one or more macro cell base stations such that the small cell base stations may supplement the coverage of the macro cell base stations. As used herein, small cells generally refer to low-powered base stations that may include or otherwise be referred to as femto cells, pico cells, micro cells, etc. As noted above, small cells may be deployed to provide improved signaling, incremental capacity growth, richer user experience, and so on.

The mixed-deployment wireless communication system 100 may comprise a multiple-access system divided into multiple cells 102A, 102B, 102C, etc. and configured to support communication various users. Communication coverage in each of the cells 102A, 102B, 102C, etc. may be provided by a corresponding base station 110, which interacts with one or more user devices 120 via downlink (DL) and/or uplink (UL) connections. In general, the DL refers to communication from a base station to a user device, while the UL refers to communication from a user device to a base station.

As will be described in more detail below, various entities in the mixed-deployment wireless communication system 100 may use LTE-D technology to select or reselect a PCI in a manner that may avoid PCI collisions and confusion and thereby support PCI self-configuration. In particular, the small cell base stations 110B, 110C may include a PCI selection module 112 that can broadcast and monitor LTE-D expressions such that the small cell base stations 110B, 110C may use the PCI selection 112 to select or reselect a PCI in a manner that may avoid collisions and confusion with PCIs that neighbor small cells may be using. For example, the small cell base stations 110B, 110C may use the PCI selection module 112 to discover LTE-D expressions broadcasted from the neighbor small cells, determine the PCIs that the neighbor small cells are using based on information in the broadcasted/discovered LTE-D expressions, and select (or reselect) a PCI that differs from the PCIs that the neighbor small cells are using. Furthermore, the PCI selection module 112 may then broadcast LTE-D expressions that include at least the selected (or reselected) PCI and optionally further include the discovered PCIs broadcasted from the neighbor small cells such that other small cells in proximity can similarly select (or reselect) PCIs in a manner that may avoid collisions and confusion. Furthermore, when the PCI selection module 112 discovers multiple LTE-D expressions that have the same PCI, the PCI selection module 112 may attempt to determine whether the multiple LTE-D expressions sharing the same PCI represents a potential PCI collision and/or confusion event (e.g., based on timing information associated with the multiple LTE-D expressions, based on the multiple LTE-D expressions having the same PCI and different eCGIs, etc.). In various embodiments, in response to determining that the multiple LTE-D expressions sharing the same PCI may represent a potential PCI collision and/or confusion event, the PCI selection module 112 may report the potential PCI collision and/or confusion event (e.g., over the network 130) such that the macro cell base station 110A, the small cells that broadcasted the LTE-D expressions sharing the same PCI, or other suitable entities on the network 130 can initiate appropriate action to resolve the potential PCI collision and/or confusion.

Returning to FIG. 1, the various base stations 110 include a macro cell base station 110A and two small cell base stations 110B, 110C. The macro cell base station 110A may provide communication coverage within a macro cell coverage area 102A, which may cover a few blocks within a neighborhood or several square miles in a rural environment. Meanwhile, the small cell base stations 110B, 110C may provide communication coverage within respective small cell coverage areas 102B, 102C, with varying degrees of overlap existing among the different coverage areas. In some systems, each cell may be further divided into one or more sectors (not shown).

Turning to the illustrated connections in more detail, the user device 120A may transmit and receive messages that include information related to various types of communication via a wireless link with the macro cell base station 110A (e.g., voice, data, multimedia services, associated control signaling, etc.). The user device 120B may similarly communicate with the small cell base station 110B via another wireless link, and the user device 120C may similarly communicate with the small cell base station 110C via another wireless link. In addition, in some scenarios, the user device 120C, for example, may also communicate with the macro cell base station 110A via a separate wireless link in addition to the wireless link it maintains with the small cell base station 110C.

As further illustrated in FIG. 1, the macro cell base station 110A may communicate with a corresponding wide area or external network 130 via a wired or wireless link, while the small cell base stations 110B, 110C may also similarly communicate with the network 130 via respective wired or wireless links. For example, the small cell base stations 110B, 110C may communicate with the network 130 over an Internet Protocol (IP) connection, such as via a Digital Subscriber Line (DSL, e.g., including Asymmetric DSL (ADSL), High Data Rate DSL (HDSL), Very High Speed DSL (VDSL), etc.), a TV cable carrying IP traffic, a Broadband over Power Line (BPL) connection, an Optical Fiber (OF) cable, a satellite link, or some other link.

The network 130 may comprise any suitable group of electronically connected computers and/or devices, including, for example, Internet, Intranet, Local Area Networks (LANs), or Wide Area Networks (WANs). In addition, connectivity to the network may be, for example, by remote modem, Ethernet (IEEE 802.3), Token Ring (IEEE 802.5), Fiber Distributed Datalink Interface (FDDI) Asynchronous Transfer Mode (ATM), Wireless Ethernet (IEEE 802.11), Bluetooth (IEEE 802.15.1), or some other connection. As used herein, the network 130 may include network variations such as the public Internet, a private network within the Internet, a secure network within the Internet, a private network, a public network, a value-added network, an intranet, and the like. In certain systems, the network 130 may also comprise a Virtual Private Network (VPN).

Accordingly, those skilled in the art will appreciate that the macro cell base station 110A and/or either or both of the small cell base stations 110B, 110C may connect to the network 130 using various devices or methods. The connections to the network 130 may be referred to as the “backbone” or the “backhaul” of the network 130, and may in some implementations be used to manage and coordinate communications between the macro cell base station 110A, the small cell base station 110B, and/or the small cell base station 110C. In this way, as a user device 120 moves through such a mixed communication network environment 100 that provides both macro and small cell coverage, the user device 120 may be served in certain locations by the macro cell base station 110A, at other locations by the small cell base station 110B, at other locations by the small cell base station 110C, and in some scenarios, by the macro cell base station 110A and one or more of the small cell base stations 110B, 110C simultaneously.

For wireless air interfaces, each base station 110 may operate according to one of several radio access technologies (RATs) depending on the network in which the base station 110 is deployed. For example, the base station 110 may be deployed in networks that include, for example, Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, and so on. The terms “network” and “system” are often used interchangeably. A CDMA network may implement a RAT such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network may implement a RAT such as Global System for Mobile Communications (GSM). An OFDMA network may implement a RAT such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). CDMA2000 is described in documents from an organization named “3rd Generation Partnership Project 2” (3GPP2). The above-mentioned documents are all publicly available.

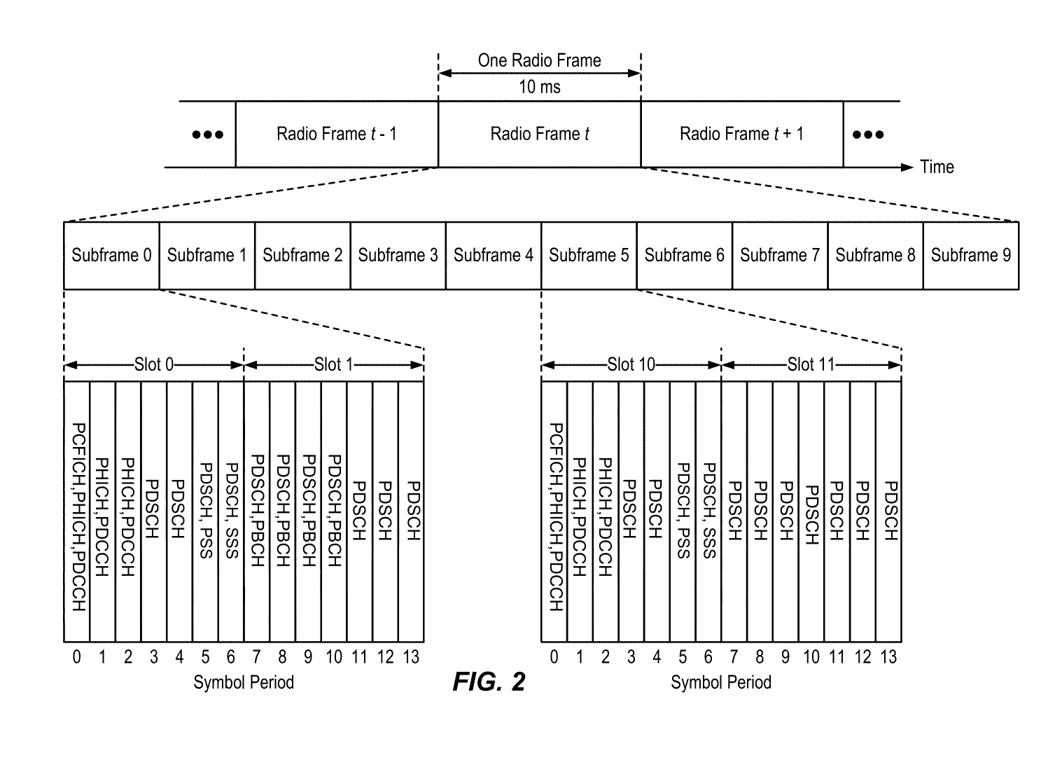

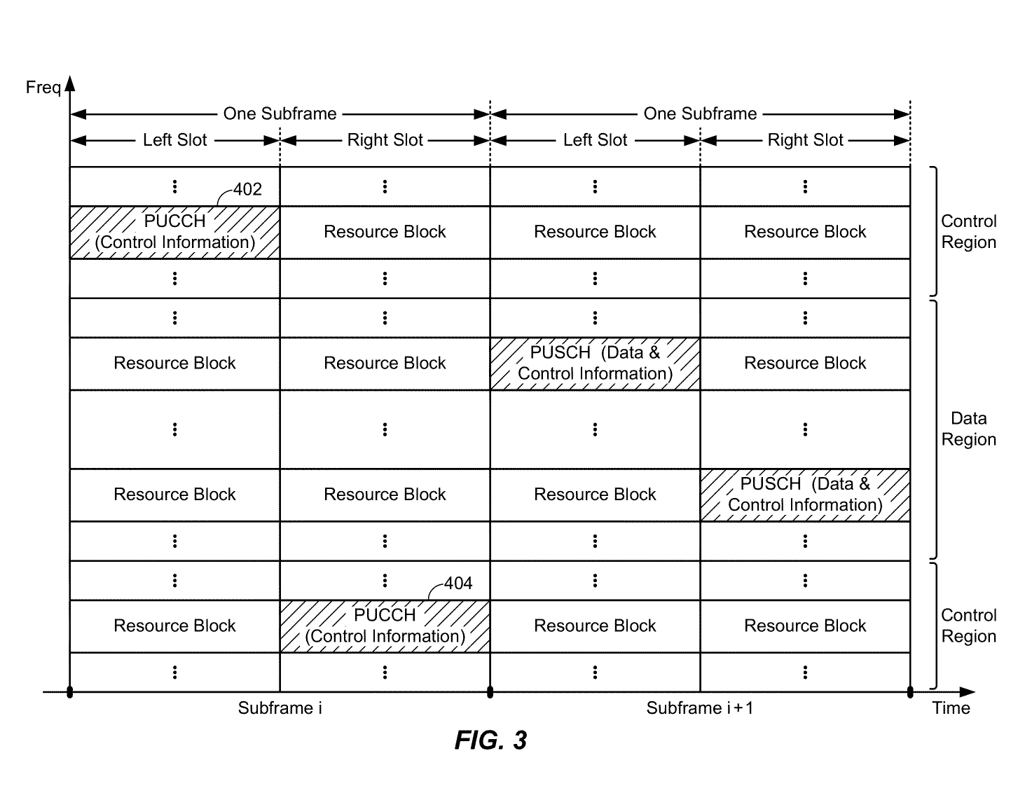

Referring now to FIG. 2 and FIG. 3, an exemplary downlink frame structure and an exemplary uplink frame structure that may be used in an LTE signaling scheme are respectively illustrated. In LTE, base stations (e.g., the base stations 110 shown in FIG. 1) are generally referred to as eNBs and user devices (e.g., the user devices 120 shown in FIG. 1) are generally referred to as UEs. Accordingly, although the following description generally uses the eNB and UE terminology, those skilled in the art will appreciate that the same terminology may refer to other suitable devices (e.g., the eNB may be an HeNB or another suitable small cell).

In FIG. 2, the downlink frame structure may include a transmission timeline partitioned into units of radio frames, where each radio frame may have a predetermined duration (e.g., 10 milliseconds (ms)) and may be partitioned into 10 subframes with indices of 0 through 9. Each subframe may include two slots and each radio frame may therefore include 20 slots with indices of 0 through 19. Each slot may include L symbol periods (e.g., 7 symbol periods for a normal cyclic prefix, as shown in FIG. 2, or 6 symbol periods for an extended cyclic prefix). The 2 L symbol periods in each subframe may be assigned indices of 0 through 2 L-1. The available time frequency resources may be partitioned into resource blocks, which may each cover N subcarriers (e.g., 12 subcarriers) in one slot.

In LTE, an eNB may send a Primary Synchronization Signal (PSS) and a Secondary Synchronization Signal (SSS) for each cell in the eNB. The PSS and SSS may be sent in symbol periods 5 and 6, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

Reference signals are transmitted during the first and fifth symbol periods of each slot when the normal cyclic prefix is used and during the first and fourth symbol periods when the extended cyclic prefix is used. For example, the eNB may send a Cell-specific Reference Signal (CRS) for each cell in the eNB on all component carriers. The CRS may be sent in symbols 0 and 4 of each slot in case of the normal cyclic prefix, and in symbols 0 and 3 of each slot in case of the extended cyclic prefix. The CRS may be used by UEs for coherent demodulation of physical channels, timing and frequency tracking, Radio Link Monitoring (RLM), Reference Signal Received Power (RSRP), and Reference Signal Received Quality (RSRQ) measurements, etc.

The eNB may send a Physical Control Format Indicator Channel (PCFICH) in the first symbol period of each subframe, as shown in FIG. 2. The PCFICH may convey the number of symbol periods (M) used for control channels, where M may equal 1, 2, or 3 and may change from one subframe to another. M may also equal 4 for a small system bandwidth (e.g., with less than 10 resource blocks). In the example shown in FIG. 2, M equals 3. The eNB may send a Physical HARQ Indicator Channel (PHICH) and a Physical Downlink Control Channel (PDCCH) in the first M symbol periods of each subframe. The PDCCH and PHICH are also included in the first three symbol periods in the example shown in FIG. 2. The PHICH may carry information to support Hybrid Automatic Repeat Request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation.”

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

Various resource elements may be available in each symbol period. Each resource element may cover one subcarrier in one symbol period and may be used to send one modulation symbol, which may be a real or complex value. Resource elements not used for a reference signal in each symbol period may be arranged into Resource Element Groups (REGs), which may each include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 32, or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH, wherein the combinations to search are typically less than the number of allowed combinations for the PDCCH. An eNB may send the PDCCH to the UE in any of the combinations that the UE will search.

Referring now to FIG. 3, an uplink frame structure for LTE communications may partition available resource blocks for the UL into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 3 results in the data section including contiguous subcarriers, which may allow one UE to be assigned all contiguous subcarriers in the data section.

A UE may be assigned resource blocks in the control section to transmit control information to an eNB. The UE may also be assigned resource blocks in the data section to transmit data to the eNB. The UE may transmit control information in a Physical Uplink Control Channel (PUCCH) on the assigned resource blocks in the control section. The UE may transmit only data or both data and control information in a Physical Uplink Shared Channel (PUSCH) on the assigned resource blocks in the data section. An uplink transmission may span both slots of a subframe and may hop across frequency.

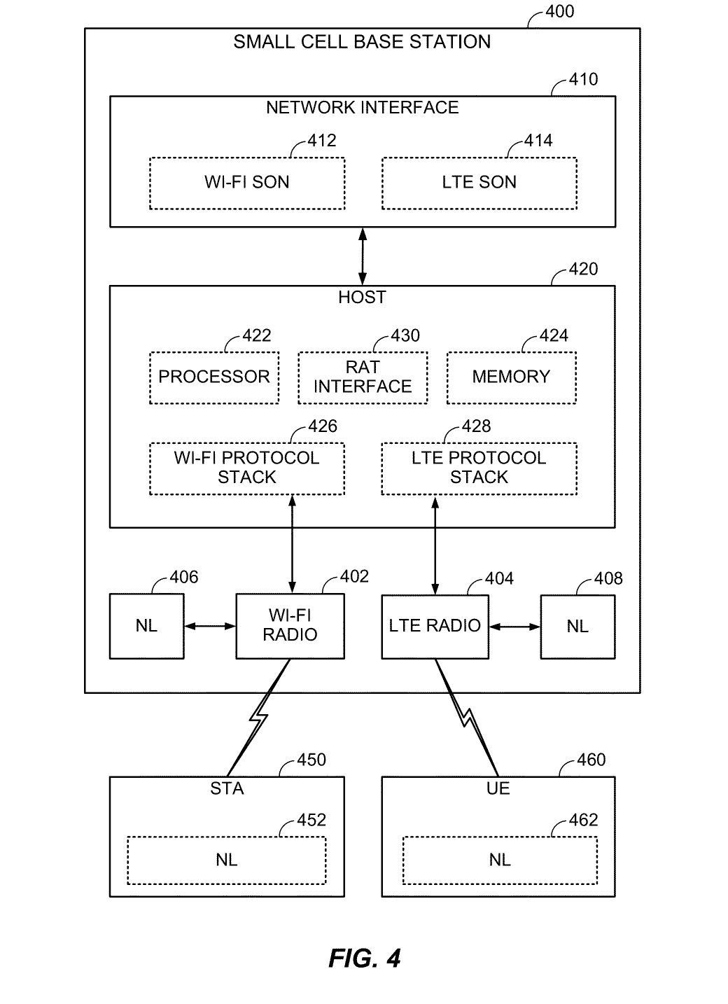

Referring to FIG. 4, an example small cell base station 400 may include co-located radio components configured for unlicensed spectrum operation. The small cell base station 400 may correspond, for example, to one of the small cell base stations 110B, 110C illustrated in FIG. 1. In this example, the small cell base station 400 may provide a WLAN air interface (e.g., in accordance with an IEEE 802.11x protocol) in addition to a cellular air interface (e.g., in accordance with an LTE protocol). For illustration purposes, the small cell base station 400 is shown as including an 802.11x radio component/module (e.g., transceiver) 402 co-located with an LTE radio component/module (e.g., transceiver) 404.

As used herein, the term co-located (e.g., radios, base stations, transceivers, etc.) may include, in accordance with various aspects, components in the same housing, components hosted by the same processor, components within a defined distance of one another, and/or components connected via an interface (e.g., an Ethernet switch) that meets latency requirements of any required inter-component communication (e.g., messaging). In some designs, the advantages discussed herein may be achieved by adding a radio component of the native unlicensed band RAT of interest to a given cellular small cell base station without that base station necessarily providing corresponding communication access via the native unlicensed band RAT (e.g., adding a Wi-Fi chip or similar circuitry to an LTE small cell base station). If desired, a low functionality Wi-Fi circuit may be employed to reduce costs (e.g., a Wi-Fi receiver simply providing low-level sniffing).

Returning to FIG. 4, the Wi-Fi radio 402 and the LTE radio 404 may monitor one or more channels (e.g., on a corresponding carrier frequency) to perform various corresponding operating channel or environment measurements (e.g., CQI, RSSI, RSRP, or other RLM measurements) using corresponding Network/Neighbor Listen (NL) modules 406 and 408, respectively, or any other suitable component(s). Furthermore, the LTE radio 404 may be configured to broadcast and monitor LTE-D expressions that may be used in PCI selection and reselection procedures, as will be described in more detail below.

The small cell base station 400 may communicate with one or more user devices via the Wi-Fi radio 402 and the LTE radio 404, illustrated as an STA 450 and a UE 460, respectively. Similar to the Wi-Fi radio 402 and the LTE radio 404, the STA 450 includes a corresponding NL module 452 and the UE 460 includes a corresponding NL module 462 to perform various operating channel or environment measurements, either independently or under the direction of the Wi-Fi radio 402 and the LTE radio 404, respectively. In this regard, the measurements may be retained at the STA 450 and/or the UE 460, or reported to the Wi-Fi radio 402 and the LTE radio 404, respectively, with or without any pre-processing being performed by the STA 450 or the UE 460.

While FIG. 4 shows a single STA 450 and a single UE 460, those skilled in the art will appreciate that such is for illustration purposes only and that the small cell base station 400 can suitably communicate with multiple STAs and/or UEs. Additionally, while FIG. 4 illustrates one type of user device communicating with the small cell base station 400 via the Wi-Fi radio 402 (i.e., the STA 450) and another type of user device communicating with the small cell base station 400 via the LTE radio 404 (i.e., the UE 460), those skilled in the art will appreciate that a single user device (e.g., a smartphone) may be capable of communicating with the small cell base station 400 via both the Wi-Fi radio 402 and the LTE radio 404, either simultaneously or at different times. Further still, while FIG. 4 shows the small cell base station 400 communicating with the UE 460 via the LTE radio 404, those skilled in the art will appreciate that the LTE radio 404 may be used to broadcast and monitor LTE-D expressions that may be exchanged with another small cell base station, a macro cell base station, and/or other suitable network entities.

As further illustrated in FIG. 4, the small cell base station 400 may also include a network interface 410, which may include various components to interface with network entities (e.g., Self-Organizing Network (SON) nodes), such as a component for interfacing with a Wi-Fi SON 412 and/or a component for interfacing with an LTE SON 414. The small cell base station 400 may also include a host 420, which may include one or more general purpose controllers or processors 422 and a memory 424 configured to store related data and/or instructions. The host 420 may perform processing in accordance with the appropriate RAT(s) used for communication (e.g., via a Wi-Fi protocol stack 426 and/or an LTE protocol stack 428), as well as other functions for the small cell base station 400. In particular, the host 420 may further include a RAT interface 430 (e.g., a bus or the like) that enables the radios 402 and 404 to communicate via various message exchanges.

In various embodiments, the small cell base station 400 may be further configured to support various different access modes. More particularly, in an open access mode, the small cell base station 400 may allow any UE to obtain any service available via the small cell base station 400, whereas in a restricted (or closed) access mode, the small cell base station 400 may only allow authorized UEs to obtain service via the small cell base station 400. For example, in the restricted (or closed) access mode, the small cell base station 400 may only allow UEs that belong to a certain subscriber group (CSG) (e.g., “home” UEs) to obtain service via the small cell base station 400. Furthermore, in a hybrid access mode, the small cell base station 400 may provide limited access to alien UEs (e.g., non-home UEs, non-CSG UEs, etc.). For example, a macro UE that does not belong to the CSG associated with the small cell base station 400 may be granted access under certain conditions (e.g., if sufficient resources are available for all home UEs that the small cell base station 400 is currently serving).

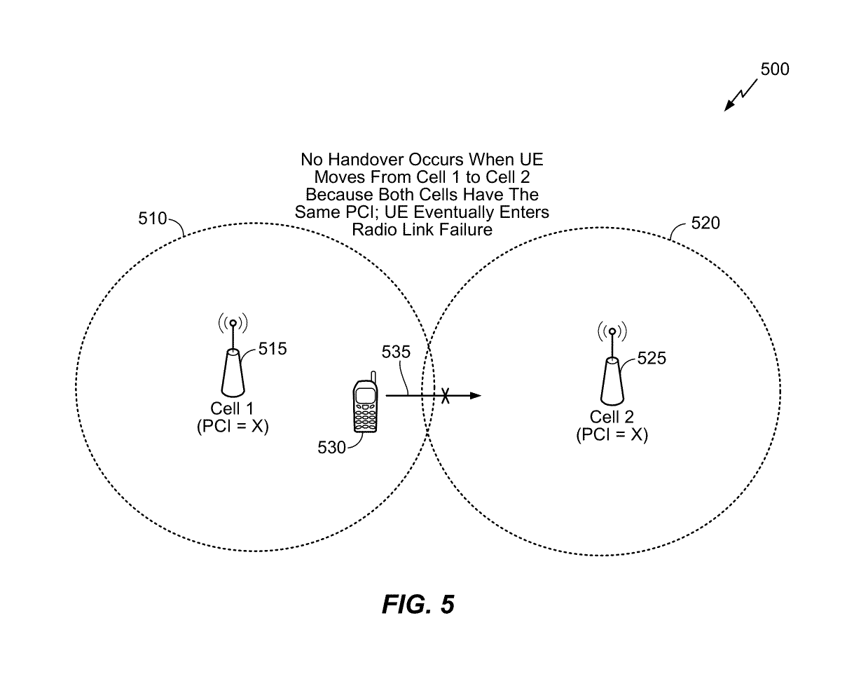

Referring now to FIG. 5, an exemplary wireless communication system 500 is illustrated in which a first small cell (Cell 1) 510 includes a first small cell base station 515 that uses a particular physical cell identifier (PCI) and a second small cell (Cell 2) 520 has a small cell base station 525 that uses the same PCI. In the wireless communication system 500, a UE 530 may initially be located in the first small cell 510, whereby the first small cell base station 515 may be serving the UE 530, and the UE 530 may subsequently move from the first small cell 510 to the second small cell 520, as depicted by line 535. However, because the first small cell 510 and the second small cell 520 use the same PCI, a PCI collision event may occur because both small cells 510, 520 may appear as one cell or otherwise be indistinguishable to the UE 530. Furthermore, because the LTE PHY layer is not designed to deal with this scenario, significant channel estimation losses may result. Further still, a handover from the first small cell 510 to the second small cell 520 may not occur because both small cells have the same PCI, and the UE 530 may eventually enter radio link failure (RLF) depending on the relative strengths of the channels from the first small cell base station 515 and the second small cell base station 525 because the small cell base stations 515, 525 may have different transmit power levels, different coverage areas, and different impacts on interference in the wireless communication system 500.

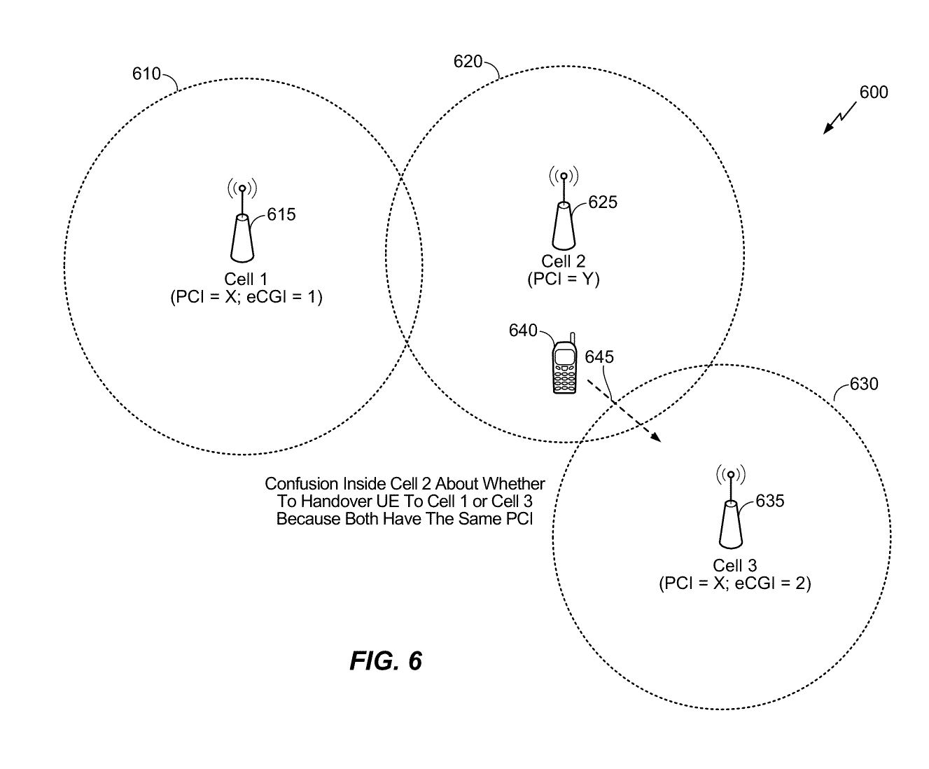

Referring now to FIG. 6, the wireless communication system 600 illustrated therein may include a deployment in which a PCI confusion event can occur. For example, as shown in FIG. 6, a UE 640 may be served in a Cell 2 620 that includes a small cell base station 625 that uses a particular PCI and has two neighbor cells, Cell 1 610 and Cell 3 630, which have respective small cell base stations 615, 635 that are using the same PCI (although the shared PCI used in the neighbor cells 610, 630 differs from the PCI used in the serving cell 620). Accordingly, when the UE 640 moves from the serving cell 620 to Cell 3 630, as depicted by line 645, confusion may arise inside the serving cell 620, in that the base station 625 in the serving cell 620 may be confused about whether to hand over the UE 640 to neighbor cell 610 or neighbor cell 630 because both neighbor cell 610 and neighbor cell 630 have the same PCI.

Accordingly, various embodiments described herein may configure a small cell to use LTE-Direct (LTE-D) technology in order to find the PCI and the E-UTRAN Cell Global Identifier (eCGI) associated with one or more neighbor small cells while booting up and to periodically read the same information while running. More particularly, because small cells are often deployed over a macro cell to increase capacity and improve performance, an operator generally cannot configure each small cell separately. Accordingly, small cells are generally enabled for self-configuration, wherein configuring small cells to find the PCI and eCGI associated with neighbor small cells may assist with avoiding PCI collision because each small cell attempts to detect nearby PCIs and avoid using the detected PCIs during PCI selection and/or reselection procedures. Moreover, configuring the small cells to find the PCI and eCGI associated with the neighbor small cells may assist with avoiding PCI confusion where a particular small cell reads multiple messages that have different eCGIs but the same PCI. As such, the small cell that detected the PCI confusion event can communicate with the neighbors that are using the same PCI about the confusion or simply pass the information on to operations, administration, and management (OAM) to resolve the issue. In the case of direct communication, the small cell can send a PCI and eCGI to only one neighbor such that the neighbor may reselect the local PCI used therein to avoid collisions and confusion with neighbor PCIs.

In various embodiments, the small cells may be configured to use LTE-D technology to read the PCI and eCGI associated with the neighbor small cells, wherein LTE-D is a proposed 3GPP (Release 12) device-to-device (D2D) solution for proximate discovery. LTE-D may dispense with location tracking and network calls, instead directly monitoring for services on other LTE-D devices within a configurable range (e.g., ˜500 m, line of sight, an application-specific range, etc.) in a substantially continuous and battery efficient manner. Among other advantages, LTE-D has a wider range than other D2D P2P technologies (e.g., Wi-Fi Direct (WFD) or Bluetooth) and provides a D2D solution that enables service layer discovery and also D2D communication at the physical layer. As such, LTE-D is an attractive alternative to deploy distributed proximity-based discovery solutions (versus centralized discovery), which may eliminate the need to have centralized processing to identify relevancy matches because relevance can instead be determined autonomously at the device level by transmitting and monitoring for relevant attributes. Furthermore, LTE-D offers certain benefits in terms of privacy as well as power consumption, in that LTE-D does not utilize perpetual location tracking to determine proximity, which may provide greater control over what information is shared with external devices because discovery is performed on the device.

In general, for both discovery of proximate peers and facilitating communication between proximate peers, LTE-D relies upon “expressions,” which may alternatively be called Proximity-based Services (ProSe) codes (“ProSe Codes”), which refers to what goes over-the-air, or ProSe application identifiers (“ProSe Application IDs”), which refers to human-readable components. Expressions at the application layer and/or the service layer are referred to as “expression names” (e.g., ShirtSale@Gap.com, Jane@Facebook.com, etc.), wherein expression names at the application layer and/or the service layer are mapped to bit-strings at the physical layer that are referred to as “expression codes”. In an example, each expression code can have a length of 192 bits (e.g., “11001111 . . . 1011”, etc.). As will be appreciated, any reference to a particular expression can refer to the expression's associated expression name, expression code, or both, depending on context, and furthermore, expressions can be either private or public based on the mapping. Public expressions are made public and can be identified by any application, whereas private expressions are targeted for specific audiences.

As such, in the various embodiments described herein, a small cell may create one or more expressions to use in LTE-D discovery messages, wherein the expressions may include at least the PCI and eCGI associated with the small cell. Additionally, in various embodiments, the expressions may optionally further include the PCIs and eCGIs associated with one or more neighbor small cells. Furthermore, in addition to broadcasting expressions, the small cell may use LTE-D discovery to monitor and decode expressions broadcasted from neighbor small cells and use the broadcasted expressions from the neighbor small cells in a PCI selection/reselection procedure designed to avoid PCI collisions and PCI confusion. Accordingly, the small cell may generally broadcast expressions and monitor (or listen) for expressions to enable PCI self-configuration. Furthermore, in various embodiments, each small cell may configure a transmit power used to broadcast the LTE-D expressions such that only nearby neighbor small cells can detect the broadcasted LTE-D expressions. More particularly, if a transmit power that a particular small cell uses to broadcast the LTE-D expression is sufficiently large, the LTE-D expression may be detected at small cells immediately neighboring the broadcasting small cell and at small cells that are neighbors of the small cells immediately neighboring the broadcasting small cell, which may result in false collision detections. For example, in FIG. 6, if Cell 3 630 uses a sufficiently large transmit power to broadcast the LTE-D expression such that Cell 1 610 can detect the LTE-D expression that Cell 3 630 broadcasted, what should be a confusion scenario arising inside Cell 2 620 due to neighboring Cell 1 610 and neighboring Cell 3 630 using the same PCI may collapse into a collision scenario because Cell 1 610 detected an LTE-D expression that includes a PCI matching the local PCI used in Cell 610, which represents a false collision detection. Accordingly, because some amount of confusion may be allowed in the network depending on the deployment scenario but collisions cannot be tolerated, each small cell may configure the transmit power used to broadcast the LTE-D expressions to ensure that the LTE-D expressions can only be detected at immediate neighbors and cannot be detected at any second (or higher) order neighbors.

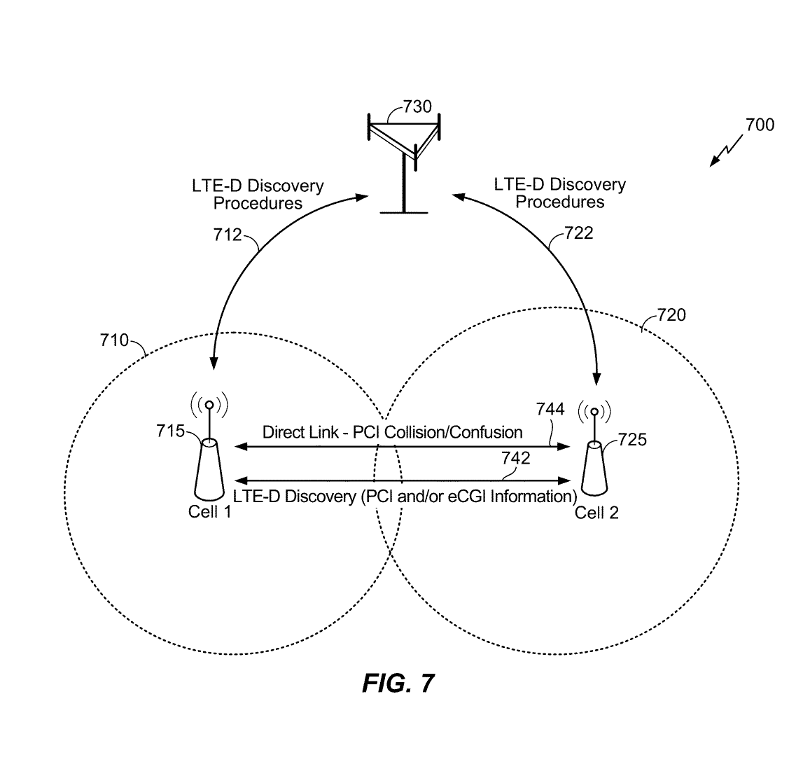

More particularly, according to various embodiments, FIG. 7 illustrates an exemplary wireless communication system 700 in which LTE-D expressions may be used to avoid PCI collision and PCI confusion. In the wireless communication system 700 shown in FIG. 7, a first small cell 710 includes a first HeNB 715, a second small cell 720 includes a second HeNB 725, and a macro eNB 730 may be in communication with both the first HeNB 715 and the second HeNB 725. Furthermore, those skilled in the art will appreciate that FIG. 7 illustrates two HeNBs for simplicity and that the same techniques described herein can be extended to multiple HeNBs with a many-to-many mapping.

In general, LTE deployments are generally either synchronous or asynchronous, wherein frame timing may be the same across all cells and transmissions from different eNBs may be approximately aligned in time in synchronous deployments. On the other hand, in asynchronous deployments, the frame timing may be different across all cells and transmissions from different eNBs may not be aligned in time.

Accordingly, assuming a synchronous deployment for the wireless communication system 700, the HeNBs 715, 725 may need to perform LTE-D discovery procedures that are facilitated through the nearest macro cell, which may comprise the macro eNB 730 in the example shown in FIG. 7. For example, performing the LTE-D discovery procedures through the macro eNB 730 may allow the HeNBs 715, 725 to decode the LTE-D expressions broadcasted from other HeNBs that are under different macro eNBs in addition to the HeNBs that are under the same macro eNB 730. As such, in a synchronous deployment, the macro eNB 730 may configure the LTE-D discovery procedures, which may involve communicating with the HeNB 715 over a first communication link 712 and communicating with the HeNB 725 over a second communication link 722. For example, the macro eNB 730 may assign frequency division duplexing (FDD) and/or time division duplexing (TDD) via a Session Information Block (SIB), which may be transmitted to the HeNBs 715, 725 over respective links 712, 722. The macro eNB 730 can also configure an interval at which the HeNBs 715, 725 announce themselves (e.g., every 20 seconds, etc.) via transmission of a Service Discovery (or P2P Discovery) message. For example, for a 10 MHz FDD system, the macro eNB 730 can allocate 44 Physical Uplink Shared Channel (PUSCH) radio bearers to be used for discovery in accordance with a periodic discovery cycle that occurs every 20 seconds and includes 64 sub-frames, such that the number of direct discovery resources (DRIDs) is 44×64=2816.

Assuming now an asynchronous deployment for the wireless communication system 700, each HeNB 715, 725 may need to tune into the discovery resources associated with the neighbor macro eNBs that the HeNBs 715, 725 can hear and for which the HeNBs 715, 725 can obtain frame timing. In this case, each HeNB 715, 725 may configure the PUSCH associated therewith in a manner that may enable the respective HeNB 715, 725 to decode expressions broadcasted over a communication link 742 from HeNBs that are under different macro eNBs. Furthermore, because some discovery messages in different macro eNBs may overlap in time, the HeNBs 715, 725 may take turns listening to the different bands/resources on communication link 742 during periodic discovery cycles that occur at different time intervals, thereby ensuring that the discovery resources associated with all neighbor macro eNBs that can be heard have been scanned.

Accordingly, in the wireless communication system 700, each HeNB 715, 725 can execute an LTE-D discovery procedure at boot up and periodically decode LTE-D expressions during runtime, wherein information obtained during the LTE-D discovery procedure and/or the periodically decoded LTE-D expressions can be used to select or reselect a PCI associated with the respective HeNB 715, 725. For example, because a small cell network deployment typically has a dynamic nature, each HeNB 715, 725 may periodically decode the LTE-D expressions that neighboring HeNBs broadcast in order to detect any PCI collisions and/or situations that could lead to PCI confusion on-the-fly. Furthermore, in order to avoid PCI collisions and PCI confusion, each HeNB 715, 725 may create a new expression each time that a new PCI is selected such that neighboring HeNBs can discover the new (reselected) PCI and thereby avoid collisions and/or confusion therewith. Further still, the PCI selection/reselection procedure based on LTE-D discovery can work in conjunction with existing procedures (e.g., UE ANR reporting, network listening, etc.), which may improve system performance. For example, the PCI selection/reselection procedure may be appropriately initiated in response to a network listening (NL) module reporting a PCI collision, and X2AP messages used to exchange information between different eNBs/HeNBs can likewise be exchanged over LTE-D.

In particular, each HeNB 715, 725 may be enabled for self-configuration, whereby each HeNB 715, 725 may discover PCIs and eCGIs that one or more neighbor small cells are using and avoid using the discovered PCIs in a local PCI selection/reselection procedure to avoid PCI collisions. Moreover, each HeNB 715, 725 may assist with detecting and avoiding PCI confusion, which may arise in scenarios where HeNB 715 and/or HeNBs 725 read multiple LTE-D expressions that have the same PCI and different eCGIs. As such, supposing that the HeNB 715 receives and decodes LTE-D expressions from the HeNB 725 and one or more other HeNBs (not shown) that have the same PCI and different eCGIs, the HeNB 715 can communicate with the neighbor HeNB 725 and/or the other HeNBs about the confusion over a direct link 744 or simply pass the information on to operations, administration, and management (OAM) to resolve the PCI confusion issue. In a similar respect, if the HeNB 715 receives and decodes an LTE-D expression from the HeNB 725 and determines that the PCI associated with the HeNB 725 matches the local PCI associated with the HeNB 715 (or vice versa) such that the PCIs associated with the HeNBs 715, 725 collide with one another, one or more of the HeNBs 715, 725 that detected the PCI collision can reselect the local PCI associated therewith or pass the information on to OAM to resolve the PCI collision, or the HeNBs 715, 725 may alternatively form the direct D2D link 744 and communicate with one another over the direct D2D link 744 to resolve the PCI collision (i.e., the HeNB 715 can instruct the HeNB 725 to reselect the PCI associated therewith and the HeNB 715 can continue to use the same local PCI). In the case of direct communication, the small cell can send a PCI and eCGI to only one neighbor such that the neighbor may reselect the PCI associated therewith in a manner that avoids collisions and confusion with neighbor PCIs. Furthermore, in various embodiments, the HeNBs 715, 725 may configure the transmit power used to broadcast the LTE-D expressions such that only immediate neighbors can detect the broadcasted LTE-D expressions and such that any second (or higher) order neighbors cannot detect the broadcasted LTE-D expressions in order to avoid potential false collision detections.

In various embodiments, each HeNB 715, 725 may further implement certain security controls to protect against spoofing, replays, and/or other activity that may cause instability in the PCI selection/reselection procedure. For example, a UE, HeNB, or other malicious device under the control of an attacker could conceivably attempt to use LTE-D discovery to announce expressions that include faked and/or changing PCIs and thereby cause instability in the PCI selection/reselection procedure. In that context, the malicious device does not necessarily have to support HeNB functionality because the PCI selection/reselection procedure may be vulnerable to attacks from any malicious device that supports LTE-D technology. For example, referring to FIG. 7, the malicious device could announce an LTE-D expression with the same PCI as one the HeNBs 715, 725 that are under the macro eNB 730, which may cause that HeNB to select a different PCI, and the malicious device could then repeat that procedure as often as the attacker wishes.

Accordingly, to minimize the above-mentioned vulnerability, each HeNB 715, 725 may implement certain security controls to protect against spoofing, replays, and/or other activity that may cause instability in the PCI selection/reselection procedure. For example, a configuration option may be defined to prevent each HeNB 715, 725 from reselecting the PCI associated therewith more frequently than may be deemed adequate for providing handoff and other UE services. In another example, the expressions broadcasted from each HeNB 715, 725 that contain the PCI/eCGI information may include a Message Integrity Check (MIC), which may be computed based on a freshness parameter, whereby the MIC may protect the entire expression against spoofing and replays in a manner similar to the protection of “open discovery” messages for UEs, as specified in 3GPP TS 33.303, which is publicly available and defines various ProSe security aspects. In particular, prior to broadcasting the announcements, the HeNBs 715, 725 may obtain a security key to use in computing the MIC included in the broadcasted announcements that relate to a local PCI selection/reselection from the macro eNB 730 or another suitable entity on the core network, and the freshness parameter used to compute the MIC may comprise a counter, a nonce (e.g., a one-time use random number), a timestamp (e.g., the current time at the core network), or any another suitable data that can be guaranteed to not repeat in a substantial time period (e.g., a year or years) such that the MIC computed therefrom can be used to verify the integrity of the broadcasted announcements because an attacker cannot replay the MIC without detection.

Furthermore, in various embodiments, the HeNBs 715, 725 may optionally further obtain the freshness parameter from the macro eNB 730 or other core network entity in the event that the HeNBs 715, 725 do not have a reliable source to obtain the freshness parameter. For example, whereas the core network generally sends the current network time to UEs under the “open discovery” standard specified in 3GPP TS 33.303 because UEs may spend substantial time sleeping or in other states that may cause local clocks at the UEs to become out-of-sync, transmitting the freshness parameter from the core network to the HeNBs 715, 725 through over-the-air (OTA) signaling may be unnecessary if all HeNBs that are hearing the announcements have the same notion of time (even second-level synchronization is sufficient). Accordingly, the HeNBs 715, 725 may either obtain the security key and the freshness parameter from the macro eNB 730 or other core network entity when the HeNBs 715, 725 do not have a reliable source to obtain the freshness parameter (e.g., where there is no synchronization), or the HeNBs 715, 725 may alternatively obtain only the security key from the macro eNB 730 or other core network entity when the HeNBs 715, 725 have the same notion of time (even if only at a second-level), in which case the freshness parameter may be determined locally.

Accordingly, in various embodiments, the HeNBs 715, 725 may use the security key obtained from the macro eNB 730 or other network entity and the freshness parameter (whether obtained from the network or determined locally) to compute a new MIC for each announcement that the HeNBs 715, 725 broadcast such that the MIC can be used to verify the integrity associated with the broadcasted announcements. For example, assuming a use case in which the HeNB 715 broadcasts an announcement and the HeNB 725 receives and decodes the announcement broadcasted from the HeNB 715, the HeNB 725 may be configured to not trust the announcement immediately. Instead, the HeNB 725 may send the announcement to the macro eNB 730 or other core network entity, which may know the security key that was provided to the HeNB 715 and therefore attempt to verify the announcement based thereon. However, including the freshness parameter used to compute the MIC in the announcement transmitted over-the-air (OTA) may be optional because the PCI selection/reselection procedure may function without the freshness parameter if the HeNB 725 hearing the announcement has the same notion of time as the broadcasting HeNB 715. On the other hand, if the freshness parameter is to be sent explicitly OTA (e.g., because the HeNBs 715, 725 are not synchronized), several options may be used. For example, where the freshness parameter comprises a timestamp, the broadcasting HeNB 715 may include the last few least significant bits (LSBs) of the timestamp in the announcement such that the monitoring HeNB 725 can guess the timestamp that was used to compute the MIC in the announcement and inform the macro eNB 730 or other network entity about the timestamp that was guessed. As such, because the macro eNB 730 or other network entity knows the security key that was provided to the broadcasting HeNB 715, the macro eNB 730 or other network entity can use the guessed timestamp sent from the monitoring HeNB 725 and the known security key to recompute the MIC, which may be compared to the MIC that was included in the announcement decoded at and reported from the monitoring HeNB 725 to verify whether the announcement is legitimate. In response to the macro eNB 730 or other network entity confirming that the announcement is legitimate based on the MIC included therein (e.g., where the MIC recomputed on the network matches the MIC reported from the monitoring HeNB 725), the HeNB 725 may use the information in the announcement from the broadcasting HeNB 715 to select or reselect a local PCI. Otherwise, the announcement may be discarded if the macro eNB 730 or other core network entity cannot confirm the legitimacy associated therewith.

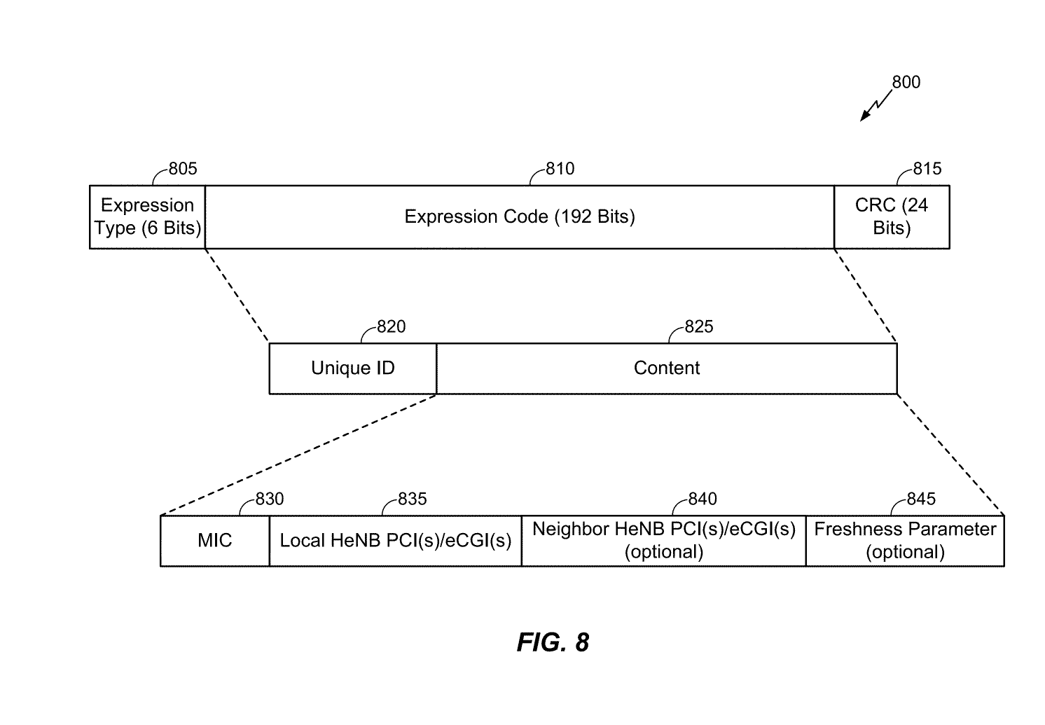

Referring now to FIG. 8, an exemplary LTE-D expression 800 that a HeNB may broadcast and/or discover and use to select or reselect a PCI to avoid collisions or confusion is illustrated, wherein the HeNB may broadcast and/or discover the LTE-D expression 800 at periodic intervals (e.g., every twenty (20) seconds). As shown in FIG. 8, the LTE-D expression 800 includes an expression type field 805 having six (6) bits, an expression code field 810 having 192 bits, and a cyclic redundancy check (CRC) field 815 having twenty-four (24) bits, which are generally encoded as a single coding block through a convolutional encoder. Furthermore, in various embodiments, the expression code field 810 may further include a Unique Identifier 820 associated with the broadcasting HeNB and one or more content fields 825 that can include other suitable data. For example, the content fields 825 may include at least a local PCI/eCGI field 835 that includes the local PCI and eCGI associated with the broadcasting HeNB and a MIC 830 that can be used to verify the integrity associated with the entire LTE-D expression 800. Furthermore, the content fields 825 may optionally further include a neighbor HeNB PCI/eCGI field 840 that includes the PCI and eCGI that the broadcasting HeNB discovered for one or more neighbor HeNBs to the extent that the number of bits available in the expression code field 810 are sufficient to include the PCI/eCGI associated with the neighbor HeNBs (and/or LTE-D technology develops to support an expression code field 810 that has a sufficient number of bits to include the PCI/eCGI associated with the neighbor HeNBs). Alternatively, the neighbor HeNB PCIs and eCGIs can be exchanged over LTE-D using X2AP messages, or the bits in the expression code field 810 may be compressed and/or encoded such that all the necessary information can be held therein.

In various embodiments, as noted above, the content fields 825 may include the MIC 830 that may protect the entire LTE-D expression 800 against spoofing and replays, wherein the MIC 830 may be computed over a bitstring based on a secret key obtained from a network entity and a freshness parameter (e.g., a counter, nonce, timestamp, etc., which may be determined locally where all HeNBs expected to hear the LTE-D expression 800 have the same notion of time or obtained from the network entity where there is no synchronization among the HeNBs expected to hear the LTE-expression 800). Furthermore, in various embodiments, the freshness parameter may be included in an optional field 845 if the freshness parameter is to be sent explicitly OTA (e.g., where there is no synchronization). For example, in use cases where the LTE-D expression 800 includes the optional freshness parameter field 845, the broadcasting HeNB may include the last few least significant bits (LSBs) of the freshness parameter used to compute the MIC 830 in the freshness parameter field 845 such that any HeNBs that decode the LTE-D expression 800 can guess the freshness parameter that was used to compute the MIC 830 and inform the network about the freshness parameter that was guessed, which may be used in combination with the known security key to verify whether the reported MIC 830 is authentic. Otherwise, if the broadcasting HeNB, the monitoring HeNB, and the core network have the same notion of time, the core network may be able to verify whether the reported MIC 830 is authentic based on the known security key and the shared notion of time that would have been used to compute the MIC 830 at the broadcasting HeNB. Accordingly, the monitoring HeNB that received the LTE-D expression 800 may use the local PCI and eCGI 835 associated with the broadcasting HeNB (and the optional neighbor PCI(s) and neighbor eCGI(s) 840 if present) in a local PCI selection/reselection procedure if the core network entity confirms that the LTE-D expression 800 is legitimate based on the MIC 830. Otherwise, the monitoring HeNB may discard the LTE-D expression 800 if the core network entity cannot confirm the legitimacy associated therewith based on the MIC 830 (and the optional freshness parameter 845 if included).

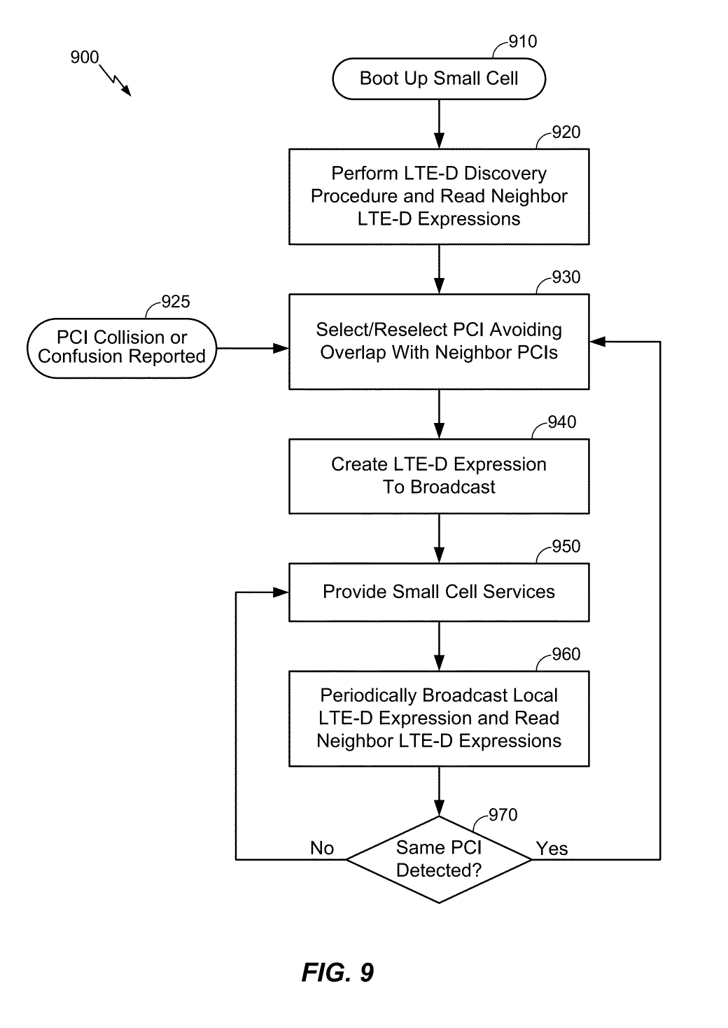

Referring now to FIG. 9, an exemplary method 900 to select or reselect a PCI in a manner that may avoid PCI collisions using LTE-D expressions is illustrated therein. More particularly, in response to a small cell starting a boot up procedure at block 910, the small cell may perform an LTE-D discovery procedure with a nearby macro eNB at block 920, and the small cell may further read one or more LTE-D expressions broadcasted from one or more neighbor small cells at block 920. More particularly, in a synchronous deployment where frame timing may be the same across all cells and transmissions from the small cell and neighboring small cells and/or other eNBs are approximately aligned in time, the nearby macro eNB may configure the LTE-D discovery procedure performed at block 920, which may involve the nearby macro eNB assigning frequency division duplexing (FDD) and/or time division duplexing (TDD) via a Session Information Block (SIB), which may be transmitted to the small cell. Furthermore, at block 920, the nearby macro eNB may configure a periodic announcement interval for the small cell via transmission of a Service Discovery (or P2P Discovery) message and allocate Physical Uplink Shared Channel (PUSCH) radio bearers to be used for discovery in accordance with a periodic discovery cycle during which the small cell reads the neighbor LTE-D expressions at block 920. Alternatively, in an asynchronous deployment where different cells may have different frame timing and transmissions from the small cell are not aligned in time with respect to the neighboring small cells and/or other eNBs in different cells, the small cell may need to tune into the discovery resources associated with the neighbor macro eNBs that the small cell can hear and for which the small cell can obtain the frame timing. In this case, at block 920, the small cell may configure the PUSCH associated therewith in a manner that may enable the small cell to decode and read the LTE-D expressions broadcasted from the neighbor small cells that are under different macro eNBs and take turns listening to the different bands/resources during periodic discovery cycles that occur at different time intervals, thereby ensuring that the discovery resources associated with all neighbor macro eNBs that can be heard have been scanned (e.g., because some discovery messages in different macro eNBs may overlap in time).

In various embodiments, whether in a synchronous deployment or an asynchronous deployment, reading the neighbor LTE-D expressions at block 920 may result in the small cell obtaining the PCIs and eCGIs associated with the neighbor small cells that broadcasted the LTE-D expressions, and the small cell may then invoke a PCI selection/reselection procedure to configure a PCI associated therewith at block 930. More specifically, at block 930, the small cell may select or reselect a unique local PCI to avoid overlap with all PCIs that were identified from the LTE-D expressions that were read at block 920, wherein the PCIs identified from the LTE-D expressions read at block 920 may include at least the PCIs associated with the neighbor small cells that broadcasted the LTE-D expressions. Furthermore, if one or more LTE-D expressions read at block 920 include PCIs and/or eCGIs associated with any neighbors of the neighbor small cells that broadcasted the LTE-D expressions, the local PCI selected or reselected at block 930 must also be unique with respect to the PCIs associated with those neighbors. In other words, the small cell may select or reselect the local PCI at block 930 that is unique with respect to every PCI that may be included in one or more of the LTE-D expressions that were read at block 920.

In various embodiments, the small cell may then create an LTE-D expression to broadcast at block 940, wherein the created LTE-D expression may include at least a local eCGI and the local PCI that was selected at block 930. Furthermore, in various embodiments, the LTE-D expression created at block 940 may optionally further include the neighbor PCIs/eCGIs that were read at block 920. In various embodiments, the small cell may further obtain a security key from a core network entity, wherein the small cell may use the security key obtained from the core network entity and a freshness parameter (e.g., a timestamp, counter, nonce, etc.) to compute a Message Integrity Check (MIC) to use in the LTE-D expression created at block 940. In response to appropriately creating the LTE-D expression, the small cell may then provide any services available through the small cell at block 950. Additionally, the small cell may periodically broadcast the local LTE-D expression at block 960, which the small cell may update at each periodic broadcast interval according to an updated time parameter that the small cell may obtain from the core network, and the small cell may further periodically discover and read LTE-D expressions broadcasted from one or more neighbor small cells in a substantially similar manner to that described above with respect to block 920. Furthermore, as noted above, the neighbor LTE-D expressions that are read at blocks 920 and 960 may be subject to a security check, wherein the small cell may send the neighbor LTE-D expressions to the network entity, which may determine whether the neighbor LTE-D expressions are legitimate based on MIC values included therein, whereby the small cell may use any neighbor LTE-D expressions that the network entity confirms are legitimate and discard any neighbor LTE-D expressions that the network entity cannot confirm are legitimate.

As such, at block 970, the small cell may determine whether a PCI collisions was detected based on the local PCI that was selected or reselected at block 930 and the PCIs included in the LTE-D expressions that were read at block 960 and confirmed to be legitimate. For example, the small cell may detect a PCI collision at block 970 in response to the local PCI that was selected or reselected at block 930 matching a PCI in one or more of the LTE-D expressions that were read at block 960, in which case the small cell may again invoke the PCI selection/reselection procedure at block 930 to self-configure a new PCI that is unique with respect to each PCI read in an LTE-D expression broadcasted from a neighbor small cell. However, in the event that the small cell does not detect any PCI collision at block 970 because the local PCI that was selected or reselected at block 930 differs from each PCI included in the LTE-D expressions that were read at block 960, small cell may continue to provide the available services at block 950 and periodically perform the procedures to broadcast and discover LTE-D expressions at block 960 to detect any PCI collisions that may subsequently arise on-the-fly.

Furthermore, as noted above, the PCI selection/reselection methodology described above can work in conjunction with existing procedures, which may include UE Automatic Neighbor Relationship (ANR) reporting, network listening, etc. Accordingly, in various embodiments, a UE, a macro eNB, a neighbor small cell, or another suitable entity may detect and report a PCI collision or PCI confusion at block 925, which may cause the small cell to invoke the PCI selection/reselection procedure at block 930 to thereby resolve the collision/confusion. For example, at block 925, the PCI collision or PCI confusion may be reported from a neighbor small cell through a peer-to-peer (P2P) message or a device-to-device (D2D) message or from operations, administration, and management (OAM), which may cause the small cell to take appropriate action to self-configure and reselect a new PCI to resolve the PCI collision/confusion issue. In particular, in response to receiving the PCI collision or PCI confusion report at block 925, the small cell may reselect a new PCI at block 930 that is unique with respect to every PCI that the small cell may have read from an LTE-D expression confirmed to be legitimate.

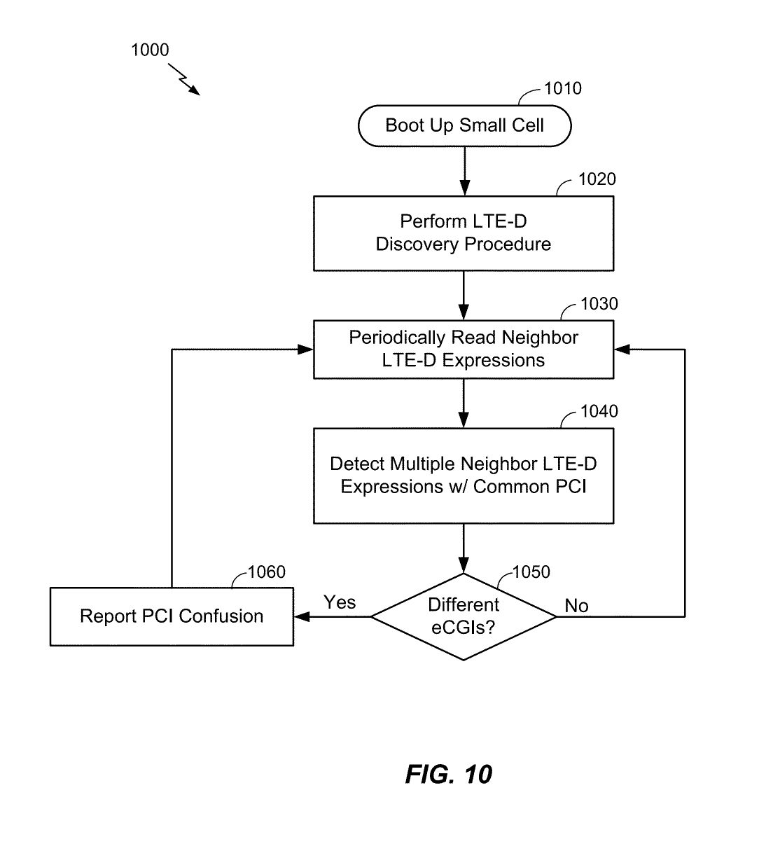

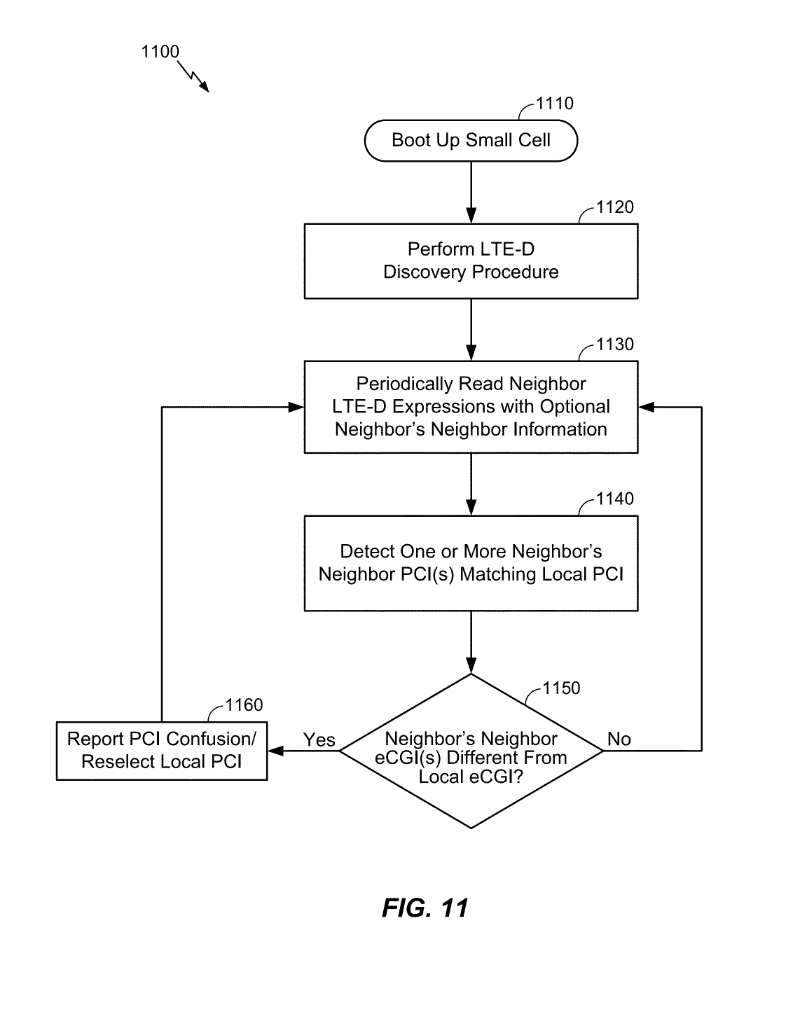

According to various aspects, FIG. 10 and FIG. 11 illustrate exemplary methods to detect and report potential PCI confusion using LTE-D expressions. In particular, there are generally two ways in which PCI confusion can be detected. First, a small cell may detect confusion where two or more immediate neighbors are using the same PCI, resulting in confusion inside the small cell that has multiple neighbors using the same PCI. Second, a small cell may detect confusion where a local PCI used in the small cell matches the PCI used in a neighbor's neighbor small cell, which may indicate potential confusion inside the neighbor small cell (i.e., the neighbor small cell has multiple small cells that are using the same PCI). In that context, FIG. 10 and FIG. 11 respectively illustrate exemplary methods to detect and report potential PCI confusion according to the first and second scenarios.

More particularly, referring to FIG. 10, an exemplary method 1000 to detect and report potential PCI confusion inside a small cell using LTE-D expressions is illustrated therein. More particularly, in response to a small cell starting a boot up procedure at block 1010, the small cell may perform an LTE-D discovery procedure with a nearby macro eNB at block 1020 in a substantially similar manner to the LTE-D discovery procedure described in further detail above with respect to FIG. 9 (e.g., communicating with an eNB in a nearest macro cell to configure announcement and discovery cycles in which the small cell broadcasts and discovers LTE-D expressions). In various embodiments, the small cell may then periodically read LTE-D expressions broadcasted from one or more neighbor small cells at block 1030 based on the announcement and discovery cycles configured according to the LTE-D discovery procedure performed at block 1020. In particular, at block 1030, the small cell may communicate with a core network entity to verify the legitimacy associated with the LTE-D expressions discovered at block 1030 and read one or more PCIs and eCGIs from each LTE-D expression that the core network entity confirms to be legitimate. In that context, the PCIs and eCGIs that are read at block 1030 may include the PCI and eCGI associated with the neighbor small cells that broadcasted the legitimate LTE-D expressions.

In various embodiments, at block 1040, the small cell may detect that multiple neighbors broadcasted LTE-D expressions that have a common PCI, which may indicate a potential PCI confusion event (i.e., different neighbors may be using the same PCI such that the small cell may be unable to distinguish the neighbors from one another). Accordingly, in response to detecting multiple LTE-D expressions that have the same PCI at block 1040, the small cell may determine whether the multiple LTE-D expressions associate the common PCI with different eCGIs at block 1050. In various embodiments, where the common PCI is associated with different eCGIs, the small cell may detect PCI confusion because the different eCGIs may indicate that different cells are indeed using the same PCI, in which case the small cell may report the PCI confusion at block 1060. For example, at block 1060, the PCI confusion may be reported to the neighbor small cell(s) that are using the same PCI based on the different eCGIs associated therewith through a peer-to-peer (P2P) or device-to-device (D2D) message, or the PCI confusion may be reported to OAM for informing the neighbor small cell(s) about the PCI confusion. Alternatively, where the common PCI is associated with the same eCGI, the small cell may not have PCI confusion because the common PCI/eCGI may simply indicate redundant information received from different neighbors (e.g., two or more neighbors may have a common neighbor such that the two or more neighbors may each include the PCI/eCGI associated with the common neighbor in the LTE-D expression, whereby the commonality between the PCI and eCGI does not raise any confusion or other ambiguity about the cell associated therewith. In either case, the small cell may continue to periodically read the LTE-D expressions broadcasted from neighbor cells at block 1030 to detect any PCI confusion that may subsequently arise on-the-fly.

Referring now to FIG. 11, an exemplary method 1100 to detect and report potential PCI confusion inside a neighbor small cell using LTE-D expressions is illustrated therein. More particularly, in response to a small cell starting a boot up procedure at block 1110, the small cell may perform an LTE-D discovery procedure with a nearby macro eNB at block 1120, which may comprise communicating with a macro eNB in a nearest macro cell to configure announcement and discovery cycles used to broadcast and discover LTE-D expressions. In various embodiments, the small cell may then periodically read LTE-D expressions broadcasted from one or more neighbor small cells at block 1130 based on the announcement and discovery cycles that were configured at block 1120, where the LTE-D expressions that are broadcasted from the neighbor small cells may include the PCI and eCGI associated with the broadcasting neighbor small cells and the optional PCI/eCGI information associated with neighbors of the broadcasting neighbor small cells.

In various embodiments, at block 1140, the small cell may detect that the local PCI used inside the small cell matches the PCI associated with one or more of the neighbors of the broadcasting neighbor small cells, which may indicate a potential PCI confusion event inside the neighbor small cell from which the matching PCI was received (i.e., the small cell carrying out the method 1100 and the neighbor's neighbor are using the same PCI, which may cause confusion inside the neighbor small cell). Accordingly, in response to detecting that the local PCI used inside the small cell matches the PCI associated with one or more of the neighbor's neighbors, the small cell may determine whether the eCGI associated with the neighbor's neighbor differs from the local eCGI at block 1150. In various embodiments, where the eCGI associated with the neighbor's neighbor differs from the local eCGI, the small cell may report the PCI confusion at block 1160 or simply reselect the local PCI to resolve the PCI confusion. For example, at block 1160, the PCI confusion may be reported to the neighbor small cell where the confusion exists through a peer-to-peer (P2P) or device-to-device (D2D) message, the PCI confusion may be reported to OAM for informing the neighbor small cell and/or the neighbor's neighbor about the PCI confusion, or the small cell may reselect the local PCI to differ from the neighbor's neighbor PCI such that the immediate neighbor will not have two neighbors with the same PCI. Alternatively, where the eCGI associated with the neighbor's neighbor is the same as the local eCGI, the small cell may not detect PCI confusion because the common PCI/eCGI may simply indicate that the neighbor small cell is including the small cell's PCI/eCGI information in the LTE-D expressions broadcasted therefrom (i.e., the small cell reading the LTE-D expression can also be characterized as the neighbor's neighbor). In either case, whether or not potential PCI confusion is detected inside the neighbor small cell, the small cell may continue to periodically read the LTE-D expressions broadcasted from neighbor cells at block 1130 to detect any PCI confusion events that may subsequently arise.

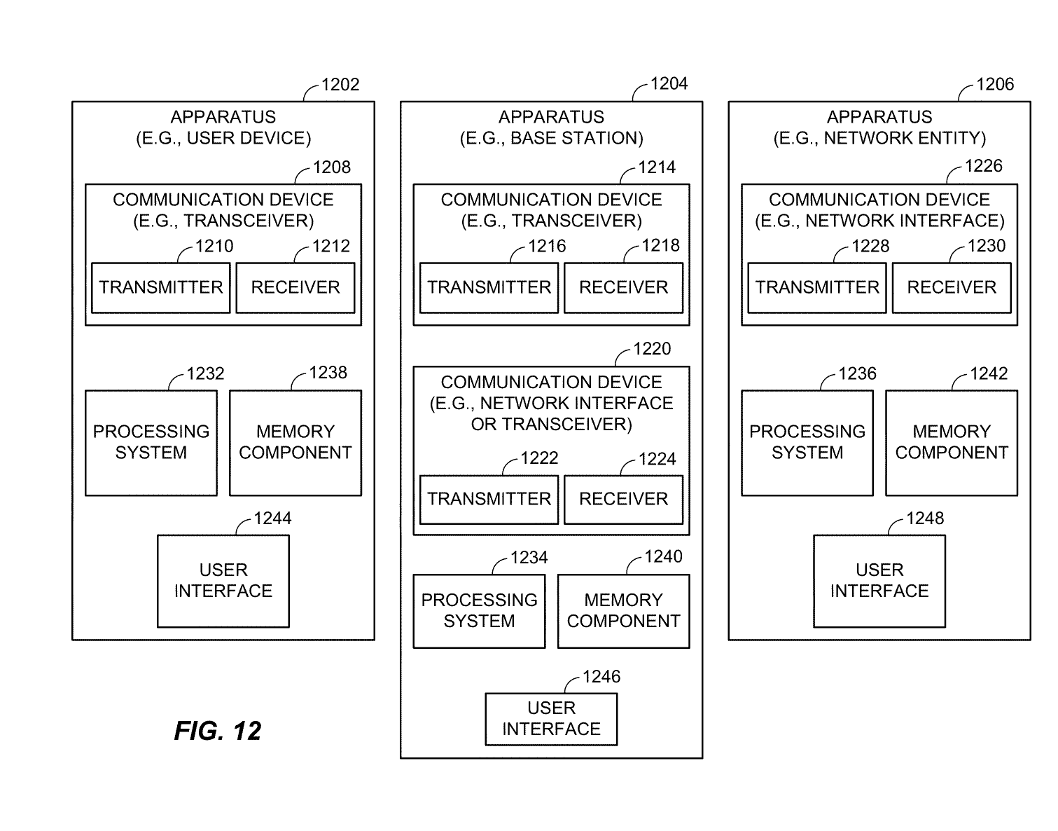

Referring now to FIG. 12, illustrated are several sample components (represented by corresponding blocks) that may be incorporated into an apparatus 1202, an apparatus 1204, and an apparatus 1206, which may correspond, for example, to a user device, a base station, and a network entity, respectively) to support the various embodiments described herein. Those skilled in the art will appreciate that these components may be implemented in different types of apparatuses in different implementations (e.g., in an ASIC, in an SoC, etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The apparatus 1202 and the apparatus 1204 each include at least one wireless communication device (represented by the communication devices 1208 and 1214 (and the communication device 1220 if the apparatus 1204 is a relay)) for communicating with other nodes via at least one designated RAT. Each communication device 1208 includes at least one transmitter (represented by the transmitter 1210) for transmitting and encoding signals (e.g., messages, indications, information, and so on) and at least one receiver (represented by the receiver 1212) for receiving and decoding signals (e.g., messages, indications, information, pilots, and so on). Similarly, each communication device 1214 includes at least one transmitter (represented by the transmitter 1216) for transmitting signals (e.g., messages, indications, information, pilots, and so on) and at least one receiver (represented by the receiver 1218) for receiving signals (e.g., messages, indications, information, and so on). If the apparatus 1204 is a relay station, each communication device 1220 may include at least one transmitter (represented by the transmitter 1222) for transmitting signals (e.g., messages, indications, information, pilots, and so on) and at least one receiver (represented by the receiver 1224) for receiving signals (e.g., messages, indications, information, etc.).

A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. A wireless communication device (e.g., one of multiple wireless communication devices) of the apparatus 1204 may also comprise a Network Listen Module (NLM) or the like for performing various measurements.

The apparatus 1206 (and the apparatus 1204 if it is not a relay station) includes at least one communication device (represented by the communication device 1226 and, optionally, 1220) for communicating with other nodes. For example, the communication device 1226 may comprise a network interface that is configured to communicate with one or more network entities via a wire-based or wireless backhaul. In some aspects, the communication device 1226 may be implemented as a transceiver configured to support wire-based or wireless signal communication. This communication may involve, for example, sending and receiving messages, parameters, or other types of information. Accordingly, in the example shown in FIG. 12, the communication device 1226 is shown as comprising a transmitter 1228 and a receiver 1230. Similarly, if the apparatus 1204 is not a relay station, the communication device 1220 may comprise a network interface that is configured to communicate with one or more network entities via a wire-based or wireless backhaul. As with the communication device 1226, the communication device 1220 is shown as comprising a transmitter 1222 and a receiver 1224.

The apparatuses 1202, 1204, and 1206 also include other components that may be used in conjunction with the various embodiments described herein. The apparatus 1202 includes a processing system 1232 for providing functionality relating to, for example, using a PCI received on a downlink to decode physical layer data being transmitted from a base station in a particular cell and for providing other processing functionality. The apparatus 1204 includes a processing system 1234 for providing functionality relating to, for example, broadcasting and monitoring LTE-D expressions that include PCI and eCGI information that may be used in a PCI selection and/or reselection procedure and for providing other processing functionality. The apparatus 1206 includes a processing system 1236 for providing functionality relating to, for example, broadcasting and monitoring LTE-D expressions that include PCI and eCGI information that may be used to assist a self-configured PCI selection and/or reselection procedure performed at a small cell base station, especially in synchronous deployments, and for providing other processing functionality. The apparatuses 1202, 1204, and 1206 include memory components 1238, 1240, and 1242 (e.g., each including a memory device), respectively, for maintaining information (e.g., information indicative of reserved resources, thresholds, parameters, and so on). In addition, the apparatuses 1202, 1204, and 1206 include user interface devices 1244, 1246, and 1248, respectively, for providing indications (e.g., audible and/or visual indications) to a user and/or for receiving user input (e.g., upon user actuation of a sensing device such a keypad, a touch screen, a microphone, and so on).

For convenience, the apparatuses 1202, 1204, and/or 1206 are shown in FIG. 12 as including various components that may be configured according to the various examples described herein. Those skilled in the art will appreciate, however, that the illustrated blocks may have different functionality in different designs.

The components of FIG. 12 may be implemented in various ways. In some implementations, the components of FIG. 12 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 1208, 1232, 1238, and 1244 may be implemented by processor and memory component(s) of the apparatus 1202 (e.g., by execution of appropriate code and/or by appropriate configuration of processor components). Similarly, some or all of the functionality represented by blocks 1214, 1220, 1234, 1240, and 1246 may be implemented by processor and memory component(s) of the apparatus 1204 (e.g., by execution of appropriate code and/or by appropriate configuration of processor components). Also, some or all of the functionality represented by blocks 1226, 1236, 1242, and 1248 may be implemented by processor and memory component(s) of the apparatus 1206 (e.g., by execution of appropriate code and/or by appropriate configuration of processor components).

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an IoT device. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, DVD, floppy disk and Blu-ray disc where disks usually reproduce data magnetically and/or optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method for avoiding physical cell identifier (PCI) collision and confusion, comprising:
discovering, at a small cell, one or more LTE-Direct expressions broadcasted from one or more neighbor small cells, wherein the one or more LTE-Direct expressions include one or more PCIs used to identify the one or more neighbor small cells;
selecting, at the small cell, a local PCI that differs from the one or more PCIs used to identify the one or more neighbor small cells; and
configuring, at the small cell, a local LTE-Direct expression to broadcast, wherein the configured local LTE-Direct expression includes at least the selected local PCI.

2. The method recited in claim 1, further comprising:
determining that the one or more discovered LTE-Direct expressions include a PCI used in one or more neighbors of at least one of the one or more neighbor small cells, wherein the local PCI selected at the small cell further differs from the PCI used in the one or more neighbors of the at least one neighbor small cell.

3. The method recited in claim 1, wherein the small cell discovers the one or more LTE-Direct expressions broadcasted from the one or more neighbor small cells according to a frame timing associated with a nearest macro cell in a synchronous deployment.

4. The method recited in claim 1, further comprising:
determining frame timing associated with a nearest macro cell and the one or more neighbor macro cells in an asynchronous deployment; and
tuning into discovery resources associated with the nearest macro cell and the one or more neighbor macro cells at different time intervals to discover neighbor small cells under the nearest macro cell and the one or more neighbor macro cells.

5. The method recited in claim 1, wherein the small cell discovers the one or more LTE-Direct expressions from the one or more neighbor small cells at boot up.

6. The method recited in claim 1, wherein the small cell discovers the one or more LTE-Direct expressions from the one or more neighbor small cell at runtime.

7. The method recited in claim 1, further comprising:
discovering one or more LTE-Direct expressions subsequent to selecting the local PCI, wherein the subsequently discovered LTE-Direct expressions include one or more PCIs used in one or more neighbor small cells that broadcasted the LTE-Direct expressions; and
reselecting the local PCI to further differ from the one or more PCIs in the one or more subsequently discovered LTE-Direct expressions in response to the selected local PCI matching the PCI in at least one of the subsequently discovered LTE-Direct expressions.

8. The method recited in claim 7, further comprising:
determining a PCI reselection frequency adequate to provide services to one or more user devices, wherein the small cell determines whether to reselect the local PCI based on whether PCI reselection has been performed at the small cell more often than the determined PCI reselection frequency.

9. The method recited in claim 1, wherein the one or more LTE-Direct expressions each further include an E-UTRAN Cell Global Identifier (eCGI) associated with the one or more neighbor small cells, and wherein the configured LTE-Direct expression further includes a local eCGI associated with the small cell.

10. The method recited in claim 9, wherein the configured local LTE-Direct expression further includes the one or more PCIs used to identify the one or more neighbor small cells and the one or more eCGIs associated with the one or more neighbor small cells.

11. The method recited in claim 9, further comprising:
determining, at the small cell, that the discovered LTE-Direct expressions include multiple LTE-Direct expressions having the same PCI; and
detecting PCI confusion inside the small cell in response to determining that the multiple LTE-Direct expressions having the same PCI include different eCGIs.

12. The method recited in claim 11, further comprising:
passing the PCI and the different eCGIs associated with the multiple LTE-Direct expressions to operations, administration, and management (OAM) to report the PCI confusion.

13. The method recited in claim 11, further comprising:
forming a direct device-to-device (D2D) link with one or more of the neighbors small cells associated with the same PCI; and
communicating over the D2D link to report the PCI confusion.

14. The method recited in claim 9, further comprising:
discovering one or more LTE-Direct expressions subsequent to selecting the local PCI, wherein the subsequently discovered LTE-Direct expressions include PCIs used in one or more neighbors of at least one neighbor small cell that broadcasted the LTE-Direct expressions;
determining, at the small cell, that the selected local PCI matches the PCI used in at least one of the neighbors of the at least one neighbor small cell; and
detecting PCI confusion inside the at least one neighbor small cell in response to determining that the local eCGI associated with the small cell differs from the eCGI associated with the at least one neighbor of the at least one neighbor small cell having the matching PCI.

15. The method recited in claim 14, further comprising:
reselecting the local PCI to differ from the one or more PCIs in the one or more discovered LTE-Direct expressions and to further differ from the PCI used in the at least one neighbor of the at least one neighbor small cell in response to detecting the PCI confusion inside the at least one neighbor small cell.

16. The method recited in claim 14, further comprising:
reporting the detected PCI confusion to one or more of operations, administration, and management (OAM) or the at least one neighbor small cell in which the PCI confusion was detected.

17. The method recited in claim 1, further comprising:
reselecting the local PCI in response to receiving a report indicating one or more of a collision or confusion associated with the selected local PCI, wherein the new local PCI is selected to differ from the PCI in any decoded LTE-Direct expressions broadcasted from neighbor small cells.

18. The method recited in claim 1, further comprising:
receiving a security key from a core network entity; and
computing a Message Integrity Check (MIC) based on the received security key and a freshness parameter, wherein the configured local LTE-Direct expression further includes the computed MIC.

19. The method recited in claim 18, wherein the freshness parameter comprises one or more of a timestamp, a counter, or a nonce.

20. The method recited in claim 1, further comprising:
transmitting at least one of the LTE-Direct expressions to a core network entity;
using the PCI included in the at least one LTE-Direct expression to select the local PCI in response to the core network entity confirming that the at least one LTE-Direct expression is legitimate based on a Message Integrity Check (MIC) included in the at least one LTE-Direct expression; and
discarding the at least one LTE-Direct expression in response to the core network entity indicating that the legitimacy of the at least one LTE-Direct expression cannot be confirmed based on the MIC included therein.

21. A small cell, comprising:
means for discovering one or more LTE-Direct expressions broadcasted from one or more neighbor small cells, wherein the one or more LTE-Direct expressions include one or more physical cell identifiers (PCIs) used to identify the one or more neighbor small cells;
means for selecting a local PCI that differs from the one or more PCIs used to identify the one or more neighbor small cells; and
means for configuring a local LTE-Direct expression to broadcast, wherein the configured local LTE-Direct expression includes at least the selected local PCI.

22. The small cell recited in claim 21, further comprising:
means for determining that the one or more discovered LTE-Direct expressions include a PCI used in one or more neighbors of at least one of the one or more neighbor small cells, wherein the local PCI selected at the small cell further differs from the PCI used in the one or more neighbors of the at least one neighbor small cell.

23. The small cell recited in claim 21, further comprising:
means for determining frame timing associated with a nearest macro cell and the one or more neighbor macro cells in an asynchronous deployment; and
means for tuning into discovery resources associated with the nearest macro cell and the one or more neighbor macro cells at different time intervals to discover neighbor small cells under the nearest macro cell and the one or more neighbor macro cells.

24. The small cell recited in claim 21, further comprising:
means for discovering one or more LTE-Direct expressions subsequent to selecting the local PCI, wherein the subsequently discovered LTE-Direct expressions include one or more PCIs used in one or more neighbor small cells that broadcasted the LTE-Direct expressions; and
means for reselecting the local PCI to differ from the one or more PCIs in the one or more subsequently discovered LTE-Direct expressions in response to the selected local PCI matching the PCI in at least one of the subsequently discovered LTE-Direct expressions.

25. The small cell recited in claim 21, wherein the one or more LTE-Direct expressions each further include an E-UTRAN Cell Global Identifier (eCGI) associated with the one or more neighbor small cells, and wherein the configured LTE-Direct expression further includes a local eCGI associated with the small cell.

26. The small cell recited in claim 25, wherein the configured local LTE-Direct expression further includes the one or more PCIs used to identify the one or more neighbor small cells and the one or more eCGIs associated with the one or more neighbor small cells.

27. The small cell recited in claim 25, further comprising:
means for determining that the discovered LTE-Direct expressions include multiple LTE-Direct expressions having the same PCI; and
means for detecting PCI confusion inside the small cell in response to determining that the multiple LTE-Direct expressions having the same PCI include different eCGIs.

28. The small cell recited in claim 27, further comprising:
means for passing the PCI and the different eCGIs associated with the multiple LTE-Direct expressions to operations, administration, and management (OAM) to report the detected PCI confusion.

29. The small cell recited in claim 27, further comprising:
means for forming a direct device-to-device (D2D) link with one or more of the neighbors small cells associated with the same PCI; and
means for communicating over the D2D link to report the detected PCI confusion.

30. The small cell recited in claim 25, further comprising:
means for discovering one or more LTE-Direct expressions subsequent to selecting the local PCI, wherein the subsequently discovered LTE-Direct expressions include PCIs used in one or more neighbors of at least one neighbor small cell that broadcasted the LTE-Direct expressions;
means for determining that the selected local PCI matches the PCI used in at least one of the neighbors of the at least one neighbor small cell; and
means for detecting PCI confusion inside the at least one neighbor small cell in response to determining that the local eCGI associated with the small cell differs from the eCGI associated with the at least one neighbor of the at least one neighbor small cell having the matching PCI.

31. The small cell recited in claim 30, further comprising:
means for reselecting the local PCI to differ from the one or more PCIs in the one or more discovered LTE-Direct expressions and to further differ from the PCI used in the at least one neighbor of the at least one neighbor small cell in response to detecting the PCI confusion inside the at least one neighbor small cell.

32. The small cell recited in claim 30, further comprising:
means for reporting the detected PCI confusion to one or more of operations, administration, and management (OAM) or the at least one neighbor small cell in which the PCI confusion was detected.

33. The small cell recited in claim 21, further comprising:
means for reselecting the local PCI in response to receiving a report indicating one or more of a collision or confusion associated with the selected local PCI, wherein the new local PCI is selected to differ from the PCI in any decoded LTE-Direct expressions broadcasted from neighbor small cells.

34. The small cell recited in claim 21, further comprising:
means for receiving a security key from a core network entity; and
means for computing a Message Integrity Check (MIC) based on the received security key, wherein the configured local LTE-Direct expression further includes the computed MIC.

35. The small cell recited in claim 21, further comprising:
means for transmitting at least one of the LTE-Direct expressions to a core network entity;
means for using the PCI included in the at least one LTE-Direct expression to select the local PCI in response to the core network entity confirming that the at least one LTE-Direct expression is legitimate based on a Message Integrity Check (MIC) included in the at least one LTE-Direct expression; and
means for discarding the at least one LTE-Direct expression in response to the core network entity indicating that the legitimacy of the at least one LTE-Direct expression cannot be confirmed based on the MIC included therein.

36. A computer-readable storage medium having computer-executable instructions recorded thereon, wherein executing the computer-executable instructions on a small cell having one or more processors causes the one or more processors to:
discover one or more LTE-Direct expressions broadcasted from one or more neighbor small cells, wherein the one or more LTE-Direct expressions include one or more physical cell identifier (PCIs) used to identify the one or more neighbor small cells;
select a local PCI that differs from the one or more PCIs used to identify the one or more neighbor small cells; and
configure a local LTE-Direct expression to broadcast, wherein the configured local LTE-Direct expression includes at least the selected local PCI.

37. The computer-readable storage medium recited in claim 36, wherein executing the computer-executable instructions on the one or more processors further causes the one or more processors to:
determine that the one or more discovered LTE-Direct expressions include a PCI used in one or more neighbors of at least one of the one or more neighbor small cells, wherein the selected local PCI further differs from the PCI used in the one or more neighbors of the at least one neighbor small cell.

38. The computer-readable storage medium recited in claim 36, wherein executing the computer-executable instructions on the one or more processors further causes the one or more processors to:
determine frame timing associated with a nearest macro cell and the one or more neighbor macro cells in an asynchronous deployment; and
tune into discovery resources associated with the nearest macro cell and the one or more neighbor macro cells at different time intervals to discover neighbor small cells under the nearest macro cell and the one or more neighbor macro cells.

39. The computer-readable storage medium recited in claim 36, wherein executing the computer-executable instructions on the one or more processors further causes the one or more processors to:
discover one or more LTE-Direct expressions subsequent to selecting the local PCI, wherein the subsequently discovered LTE-Direct expressions include one or more PCIs used in neighbor small cells that broadcasted the LTE-Direct expressions; and
reselect the local PCI to further differ from the one or more PCIs in the one or more subsequently discovered LTE-Direct expressions in response to the selected local PCI matching the PCI in at least one of the subsequently discovered LTE-Direct expressions.

40. The computer-readable storage medium recited in claim 36, wherein the one or more LTE-Direct expressions further include an E-UTRAN Cell Global Identifier (eCGI) associated with the one or more neighbor small cells, and wherein the configured LTE-Direct expression further includes a local eCGI associated with the small cell.

41. The computer-readable storage medium recited in claim 40, wherein the configured local LTE-Direct expression further includes the one or more PCIs used to identify the one or more neighbor small cells and the one or more eCGIs associated with the one or more neighbor small cells.

42. The computer-readable storage medium recited in claim 40, wherein executing the computer-executable instructions on the one or more processors further causes the one or more processors to:
determine that the discovered LTE-Direct expressions include multiple LTE-Direct expressions having the same PCI; and
detect PCI confusion inside the small cell in response to determining that the multiple LTE-Direct expressions having the same PCI include different eCGIs.

43. The computer-readable storage medium recited in claim 42, wherein executing the computer-executable instructions on the one or more processors further causes the one or more processors to:
pass the PCI and the different eCGIs associated with the multiple LTE-Direct expressions to operations, administration, and management (OAM) to report the detected PCI confusion.

44. The computer-readable storage medium recited in claim 42, wherein executing the computer-executable instructions on the one or more processors further causes the one or more processors to:
form a direct device-to-device (D2D) link with one or more of the neighbors small cells associated with the same PCI; and
communicate over the D2D link to report the detected PCI confusion.

45. The computer-readable storage medium recited in claim 40, wherein executing the computer-executable instructions on the one or more processors further causes the one or more processors to:
discover one or more LTE-Direct expressions subsequent to selecting the local PCI, wherein the subsequently discovered LTE-Direct expressions include PCIs used in one or more neighbors of at least one neighbor small cell that broadcasted the LTE-Direct expressions;
determine that the selected local PCI matches the PCI used in at least one of the neighbors of the at least one neighbor small cell; and
detect PCI confusion inside the at least one neighbor small cell in response to determining that the local eCGI associated with the small cell differs from the eCGI associated with the at least one neighbor of the at least one neighbor small cell having the matching PCI.

46. The computer-readable storage medium recited in claim 45, wherein executing the computer-executable instructions on the one or more processors further causes the one or more processors to:
reselect the local PCI to differ from the one or more PCIs in the one or more discovered LTE-Direct expressions and to further differ from the PCI used in the at least one neighbor of the at least one neighbor small cell in response to detecting the PCI confusion inside the at least one neighbor small cell.

47. The computer-readable storage medium recited in claim 45, wherein executing the computer-executable instructions on the one or more processors further causes the one or more processors to:
report the detected PCI confusion to one or more of operations, administration, and management (OAM) or the at least one neighbor small cell in which the PCI confusion was detected.

48. The computer-readable storage medium recited in claim 36, wherein executing the computer-executable instructions on the one or more processors further causes the one or more processors to:
reselect the local PCI in response to receiving a report indicating one or more of a collision or confusion associated with the selected local PCI, wherein the new local PCI is selected to differ from the PCI in any decoded LTE-Direct expressions broadcasted from neighbor small cells.

49. The computer-readable storage medium recited in claim 36, wherein executing the computer-executable instructions on the one or more processors further causes the one or more processors to:
receive a security key from a core network entity; and
compute a Message Integrity Check (MIC) based on the received security key, wherein the configured local LTE-Direct expression further includes the computed MIC.

50. The computer-readable storage medium recited in claim 36, wherein executing the computer-executable instructions on the one or more processors further causes the one or more processors to:
transmit at least one of the LTE-Direct expressions to a core network entity;
use the PCI included in the at least one LTE-Direct expression to select the local PCI in response to the core network entity confirming that the at least one LTE-Direct expression is legitimate based on a Message Integrity Check (MIC) included in the at least one LTE-Direct expression; and
discard the at least one LTE-Direct expression in response to the core network entity indicating that the legitimacy of the at least one LTE-Direct expression cannot be confirmed based on the MIC included therein.

51. A method for detecting physical cell identifier (PCI) confusion, comprising:
discovering, at a small cell, a first LTE-Direct expression broadcasted from a first neighbor small cell, wherein the first LTE-Direct expression includes at least a first PCI and a first E-UTRAN Cell Global Identifier (eCGI) associated with the first neighbor small cell;
discovering, at the small cell, a second LTE-Direct expression broadcasted from a second neighbor small cell, wherein the second LTE-Direct expression includes at least a second PCI and a second eCGI associated with the second neighbor small cell; and
detecting, at the small cell, PCI confusion in response to determining that the first PCI matches the second PCI and the first eCGI differs from the second eCGI.

52. The method recited in claim 51, further comprising:
forming a direct device-to-device (D2D) link with one or more of the first neighbor small cell or the second neighbor small cell; and
communicating over the D2D link to instruct either the first neighbor small cell to change the first PCI or the second neighbor small cell to change the second PCI.

53. The method recited in claim 51, further comprising:
passing the matching PCI, the first eCGI, and the second eCGI to operations, administration, and management (OAM) to report the detected PCI confusion.

54. A small cell, comprising:
means for discovering a first LTE-Direct expression broadcasted from a first neighbor small cell, wherein the first LTE-Direct expression includes at least a first physical cell identifier (PCI) and a first E-UTRAN Cell Global Identifier (eCGI) associated with the first neighbor small cell;
means for discovering a second LTE-Direct expression broadcasted from a second neighbor small cell, wherein the second LTE-Direct expression includes at least a second PCI and a second eCGI associated with the second neighbor small cell; and
means for detecting PCI confusion in response to determining that the first PCI matches the second PCI and the first eCGI differs from the second eCGI.

55. A computer-readable storage medium having computer-executable instructions recorded thereon, wherein executing the computer-executable instructions on one or more processors causes the one or more processors to:
discover a first LTE-Direct expression broadcasted from a first neighbor small cell, wherein the first LTE-Direct expression includes at least a first physical cell identifier (PCI) and a first E-UTRAN Cell Global Identifier (eCGI) associated with the first neighbor small cell;
discover a second LTE-Direct expression broadcasted from a second neighbor small cell, wherein the second LTE-Direct expression includes at least a second PCI and a second eCGI associated with the second neighbor small cell; and
detect PCI confusion in response to determining that the first PCI matches the second PCI and the first eCGI differs from the second eCGI.

56. A method for detecting physical cell identifier (PCI) confusion, comprising:
discovering, at a small cell, an LTE-Direct expression broadcasted from a neighbor small cell, wherein the LTE-Direct expression includes a PCI and an E-UTRAN Cell Global Identifier (eCGI) associated with a neighbor of the neighbor small cell; and
detecting, at the small cell, PCI confusion inside the neighbor small cell in response to the PCI included in the discovered LTE-Direct expression matching a local PCI used in the small cell and that the eCGI included in the discovered LTE-Direct expression differing from a local eCGI used in the small cell.

57. The method recited in claim 56, further comprising:
reselecting the local PCI used in the small cell to differ from a PCI used in the neighbor small cell and to further differ from the PCI associated with the neighbor of the neighbor small cell that matches the local PCI.

58. The method recited in claim 56, further comprising:
forming a direct device-to-device (D2D) link with the neighbor small cell; and
communicating over the D2D link to inform the neighbor small cell about the PCI confusion detected inside the neighbor small cell.

59. The method recited in claim 56, further comprising:
passing the local PCI that matches the PCI associated with the neighbor of the neighbor small cell, the eCGI associated with the neighbor of the neighbor small cell, and the local eCGI used in the small cell to operations, administration, and management (OAM) to report the PCI confusion detected inside the neighbor small cell.

60. A small cell, comprising:
means for discovering an LTE-Direct expression broadcasted from a neighbor small cell, wherein the LTE-Direct expression includes a PCI and an E-UTRAN Cell Global Identifier (eCGI) associated with a neighbor of the neighbor small cell; and
means for detecting PCI confusion inside the neighbor small cell in response to the PCI included in the discovered LTE-Direct expression matching a local PCI used in the small cell and that the eCGI included in the discovered LTE-Direct expression differing from a local eCGI used in the small cell.

61. A computer-readable storage medium having computer-executable instructions recorded thereon, wherein executing the computer-executable instructions on one or more processors causes the one or more processors to:
discover an LTE-Direct expression broadcasted from a neighbor small cell, wherein the LTE-Direct expression includes a PCI and an E-UTRAN Cell Global Identifier (eCGI) associated with a neighbor of the neighbor small cell; and
detect PCI confusion inside the neighbor small cell in response to the PCI included in the discovered LTE-Direct expression matching a local PCI used in the small cell and that the eCGI included in the discovered LTE-Direct expression differing from a local eCGI used in the small cell.
